(19) United States
(12) Patent Application Publication
(10) Pub. No.: US 2024/0198235 A1
(43) Pub. Date: Jun. 20, 2024

(54) INFORMATION PROCESSING SYSTEM, INFORMATION PROCESSING METHOD, AND COMPUTER PROGRAM

(71) Applicant: GREE, INC., Tokyo (JP)

(72) Inventors: Yoshiki KUDO, Tokyo (JP); Keisuke YAMAGA, Tokyo (JP); Minami YAMAMOTO, Tokyo (JP); Kodai MIYAKE, Kanagawa (JP); Seiji OCHIAI, Saitama (JP)

(73) Assignee: GREE, INC., Tokyo (JP)

(21) Appl. No.: 18/223,172

(22) Filed: Jul. 18, 2023

(30) Foreign Application Priority Data
Dec. 20, 2022 (JP) 2022-202781

(51) Int. Cl. A63F 13/69; A63F 13/52; A63F 13/533; A63F 13/537; A63F 13/87

(52) U.S. Cl. CPC A63F 13/69; A63F 13/52; A63F 13/533; A63F 13/537; A63F 13/87

(57) ABSTRACT

An information processing system includes one or more computer processors programmed to generate information for displaying a video on a user terminal, receive a lottery request, execute a lottery process, determine whether or not a first item determined by the lottery process can be changed to a second item related to the first item, and generate information for displaying in the video a result screen showing a result of the lottery process, the result screen including an image of the first item determined to be changeable to the second item.

This application claims the benefit of priority from Japanese Patent Application No. 2022-202781 filed Dec. 20, 2022, the entire contents of the prior application being incorporated herein by reference.

### TECHNICAL FIELD

This disclosure relates to an information processing system, an information processing method, and a computer program.

### BACKGROUND TECHNOLOGY

An information processing system is known that generates an animation of a character object based on movement of a user and distributes a video including the animation of the character object.

Also, generally, the external appearance of the character object is created by combining parts selected by the user.

### SUMMARY

### Problems to be Solved

Here, parts that generate a character object include, in addition to parts that are provided free of charge, parts that can be obtained with a predetermined probability by holding a lottery such as a gacha, but depending on the probability that has been set, there are some parts that are extremely difficult to obtain.

Accordingly, it is an object of this disclosure to provide technical improvements that solve or alleviate at least part of the problem of the conventional technology described above.

One of the specific objects of this disclosure is to provide an information processing system, an information processing device, an information processing method, and a computer program that expand means for obtaining parts.

### Means for Solving the Problems

An information processing of this disclosure is an information processing system comprising one or more computer processors, wherein the one or more computer processors comprises: (i) a generator that generates information for displaying, on at least a first user terminal, a video that displays at least a first user's character object in a virtual space; (ii) a receiver that receives a lottery request for an item from the first user terminal; (iii) a processor that executes a lottery process that determines through lottery at least one item from among an item group including a plurality of items, in response to the receiver receiving the lottery request; (iv) a change determination portion that determines whether or not a first item determined by the lottery process executed by the processor can be changed to a second item related to the first item; and (v) a screen generator that generates information for displaying in the video a result screen showing a result of the lottery process executed by the processor, the result screen including an image of the first item determined to be changeable to the second item by the change determination portion.

The change determination portion can determine that the first item is replaceable with the second item when the second item is not yet associated with the first user, and when the second item is an item determined by a lottery process executed by the processor.

The screen generator can further generate information for displaying in the video a change screen for changing the first item to the second item in response to an image of the first item, determined by the change determination portion to be changeable to the second item, being selectably displayed on the result screen and an image of the selectably displayed first item being selected by the first user, the change screen selectably displaying an image of the second item determined to be substitutable for the first item by the change determination portion.

The screen generator can further generate information for displaying in the video a confirmation screen for associating the second item with the first user, in response to the first user selecting an image of the second item selectably displayed on the change screen, and the one or more computer processors can further comprise an association portion that stores the second item in association with the first user, in response to the receiver receiving a confirmation operation by the first user via the confirmation screen.

If the application terminates without the receiver receiving a confirmation operation by the first user, the screen generator can generate information for displaying in the video any one of the result screen, the change screen or the confirmation screen when the receiver subsequently receives a lottery request for an item from the first user terminal or when the receiver receives a display request for an item stored in association with the first user.

The screen generator can further change an image of the first item displayed on the result screen to an image of the second item, in response to an image of the second item selectably displayed on the change screen being selected by the first user.

The screen generator can display a predetermined icon attached to an image of the first item that is displayed on the result screen and that is determined to be changeable to the second item by the change determination portion.

When there is a plurality of second items with which the first item can be replaced, the screen generator can determine the display order and/or the display format of images of the second items selectably displayed on the change screen, based on user information and/or event information associated with the second items.

The user information associated with the second item can be the number of users associated with the second item.

The users associated with the second item can be users having a predetermined relationship with the first user.

The generator can further generate information for displaying a video on a second user terminal of a second user.

The receiver can further receive, from the second user terminal, a comment about the video and/or a display request for an object.

The receiver can further receive, from the first user terminal, a switch operation for displaying or not displaying the comment and/or the object in the video during displaying of the result screen.

The switch operation can be an operation that selects a region of the video outside the result screen.

When the comment and/or the object are displayed through the switch operation received by the receiver, the generator can change the display format of the comment and/or the object so that the comment and/or the object is displayed avoiding the result screen displayed in the video.

The one or more computer processors can further comprise a request determination portion that determines whether or not the lottery request is a lottery request for a specific item group, and the change determination portion can determine whether or not the change is possible when the request determination portion determines that the lottery request is a lottery request for a specific item group.

The second item can be an item that differs only in color and/or texture from the first item.

The item can be a part that makes up the character object.

The one or more computer processors can further comprise a sending determination portion that determines whether information for displaying the video is being sent to a second user terminal of a second user; and as a result of the determination by the sending determination portion, the change determination portion can vary the number and/or type of second items determined to be substitutable for (i) the case in which it is determined that information for displaying the video is being sent to the second user terminal and (ii) the case in which it is determined that information for displaying the video is not being sent to the second user terminal.

The one or more computer processors can further comprise a counter that counts the number of comments and/or display requests for the object received from the second user terminal by the receiver; and the change determination portion can vary the number and/or type of second items determined to be substitutable, in accordance with the number counted by the counter.

When there is a plurality of second items determined by the change determination portion to be substitutable, the receiver can receive a bulk change request that can change in bulk each of the first items to corresponding second items, and the bulk change request can include a specification of one color.

The one or more computer processors can further comprise an association determination portion that determines whether a specific electronic medium is associated with the first user, and the change determination portion can determine whether the change is possible, when it is determined by the association determination portion that the specific electronic medium is associated with the first user.

The receiver, in advance of receiving a confirmation operation from the first user via the confirmation screen, can receive a reset request that can return a post-change item to a pre-change item.

The receiver, in advance of receiving a confirmation operation from the first user via the confirmation screen, can receive a conversion request that can convert into points a first item that is the same as an item already associated with the first user.

An information processing method in this disclosure is an information processing method in an information processing system comprising one or more computer processors, the information processing method causing the one or more computer processors to execute: (i) a step that generates information for displaying, on at least a first user terminal, a video displaying at least a first user's character object in a virtual space; (ii) a step that receives a lottery request for an item from the first user terminal; (iii) a step that executes a lottery process that determines through lottery at least one item from among an item group including a plurality of items, in response to receiving the lottery request; (iv) a step that determines whether or not a first item determined by the lottery process can be changed to a second item related to the first item; and (v) a step that generates information for displaying in the video a result screen showing a result of the lottery process, the result screen including an image of the first item determined to be changeable to the second item.

An information processing method in this disclosure is an information processing method in an information processing device comprising one or more computer processors, the information processing method causing the one or more computer processors to execute: (i) a step that displays a video displaying at least a first user's character object in a virtual space; (ii) a step that receives a lottery request for an item; and (iii) a step that displays a result screen displaying an image of a first item decided by a lottery process executed in response to the lottery request being received, the first item being determined to be changeable to a second item, in a manner differing from an image of an item determined not to be changeable to a second item.

A computer program in this disclosure is executed in an information processing device comprising one or more computer processors, the computer program causing the one or more computer processors to realize: (i) a function that displays a video displaying at least a first user's character object in a virtual space; (ii) a function that receives a lottery request for an item; and (iii) a function that displays a result screen displaying an image of a first item decided by a lottery process executed in response to the lottery request being received, the first item being determined to be changeable to a second item, in a manner differing from an image of an item determined not to be changeable to a second item.

### Effects

According to this disclosure, a technical improvement that solves or alleviates at least part of the problem of the conventional technology described above can be provided. Specifically, according to this disclosure, it is possible to provide an information processing system, an information processing device, an information processing method, and a computer program that expand means for obtaining parts.

### BRIEF DESCRIPTION OF DRAWINGS

FIG. 1 is a system configuration diagram showing an example of an information processing system in this disclosure.

FIG. 2 is a system configuration diagram showing an example of an information processing system in this disclosure.

FIG. 3 is a system configuration diagram showing an example of an information processing system in this disclosure.

FIG. 4 is a configuration diagram showing an example of a hardware configuration of a server device, a first user terminal, and a second user terminal in this disclosure.

FIG. 5 is a conceptual diagram showing an image of a screen displayed on a user terminal.

FIG. 6 is a conceptual diagram showing an image of a screen displayed on a user terminal.

FIG. 7 is a conceptual diagram showing an image of a screen displayed on a user terminal.

FIG. 8 is a conceptual diagram showing an image of a screen displayed on a user terminal.

FIG. 9 is a conceptual diagram showing an image of a screen displayed on a user terminal.

FIG. 10 is a conceptual diagram showing an image of a screen displayed on a user terminal.

FIG. 11 is a conceptual diagram showing an image of a screen displayed on a user terminal.

FIG. 12 is a conceptual diagram showing an image of a screen displayed on a user terminal.

FIG. 13 is a conceptual diagram showing an image of a screen displayed on a user terminal.

FIG. 14 is a conceptual diagram showing an image of a screen displayed on a user terminal.

FIG. 15 is a conceptual diagram showing an image of a screen displayed on a user terminal.

FIG. 16 is a conceptual diagram showing an image of a screen displayed on a user terminal.

FIG. 17 is a conceptual diagram showing an image of a screen displayed on a user terminal.

FIG. 18 is a conceptual diagram showing an image of a screen displayed on a user terminal.

FIG. 19 is a conceptual diagram showing an image of a screen displayed on a user terminal.

FIG. 20 is a conceptual diagram showing an image of a screen displayed on a user terminal.

FIG. 21 is a conceptual diagram showing an image of a screen displayed on a user terminal.

FIG. 22 is a conceptual diagram showing an image of a screen displayed on a user terminal.

FIG. 23 is a conceptual diagram showing an image of a screen displayed on a user terminal.

FIG. 24 is a conceptual diagram showing an image of a virtual space described in this disclosure.

FIG. 25 is a configuration diagram showing an example of a functional configuration of a server device in this disclosure.

FIG. 26 is a conceptual diagram showing an image of a screen displayed on a user terminal.

FIG. 27 is a conceptual diagram showing an image of a screen displayed on a user terminal.

FIG. 28 is a conceptual diagram showing an image of a screen displayed on a user terminal.

FIG. 29 is a conceptual diagram showing an image of a screen displayed on a user terminal.

FIG. 30 is a conceptual diagram showing an image of a screen displayed on a user terminal.

FIG. 31 is a conceptual diagram showing an image of a screen displayed on a user terminal.

FIG. 32 is a conceptual diagram showing an image of a screen displayed on a user terminal.

FIG. 33 is a conceptual diagram showing an image of a screen displayed on a user terminal.

FIG. 34 is a conceptual diagram showing an image of a screen displayed on a user terminal.

FIG. 35 is a conceptual diagram showing an image of a screen displayed on a user terminal.

FIG. 36 is a conceptual diagram showing an image of a screen displayed on a user terminal.

FIG. 37 is a configuration diagram showing another example of a functional configuration of a server device in this disclosure.

FIG. 38 is a conceptual diagram showing an image of a screen displayed on a user terminal.

FIG. 39 is a conceptual diagram showing an image of a screen displayed on a user terminal.

FIG. 40 is a conceptual diagram showing an image of a screen displayed on a user terminal.

FIG. 41 is a conceptual diagram showing an image of a screen displayed on a user terminal.

FIG. 42 is a flow diagram showing an example of the flow of an information processing method in this disclosure.

FIG. 43 is a circuit configuration diagram showing an example of a circuit configuration for realizing a computer program in this disclosure.

FIG. 44 is a configuration diagram showing an example of a functional configuration of a first user terminal in this disclosure.

FIG. 45 is a flow diagram showing an example of the flow of an information processing method in a first user terminal in this disclosure.

FIG. 46 is a circuit configuration diagram showing an example of a circuit configuration for realizing a computer program executed by a first user terminal in this disclosure.

FIG. 47 is a block diagram of a processing circuit that executes computer-based operations in this disclosure.

### DETAILED DESCRIPTION OF EMBODIMENTS

First, an overview of an information processing system according to an embodiment of this disclosure will be described with reference to the drawings.

The information processing system in this disclosure is an information processing system including one or more client devices and a server device, and includes one or more computer processors.

A video displayed on each client device is described as including an animation of a 3D or 2D character object generated based on movement of a distributing user, but the description is not limited to this, and the video may include an animation of a character object generated in response to an operation by the distributing user, or may include an image of the distributing user himself/herself. Further, the video may also include only the voice of the distributing user, without displaying a character object or the distributing user.

Here, a distributing user means a user who sends information related to video and/or sound. For example, a distributing user can be a user who organizes or hosts a single video distribution, a collaborative distribution in which multiple people can participate, a video or voice chat that multiple people can participate in and/or view, or an event (for example, a party) in a virtual space that multiple people can participate in and/or view, that is, a user who mainly performs these functions. Therefore, the distributing user in this disclosure can also be called a host user, a sponsor user, a hosting user, or the like.

Meanwhile, a viewing user means a user who receives information related to video and/or sound. However, the viewing user can be a user who not only receives the above information, but can also react to it. For example, a viewing user can be a user who views a video distribution, a collaborative distribution, or a user who participates in and/or views a video or voice chat, or an event. Therefore, the viewing user in this disclosure can also be referred to as a guest user, a participating user, a listener, a spectator user, a cheering user, or the like.

The information processing system in an embodiment of this disclosure can be used to provide the next Internet space (metaverse), which is a digital world in which many people can participate simultaneously and freely engage in activities such as interaction, work, and play via character objects (avatars) at a level close to that of the real world. Social activities can be carried out transcending the gap between reality and virtuality.

In such a space, user avatars can freely walk around the world and communicate with each other.

Additionally, one avatar (character object) among the plurality of avatars in the virtual space may be configured to be able to distribute a video as a character object of a distributing user. That is, one-to-many video distribution can be performed in a many-to-many metaverse virtual space.

In such a space, there may be no particular distinction between a distributing user and a viewing user.

The space displayed in the video may be a virtual space, a real space, or an augmented reality space that is a combination thereof. The video may be a karaoke video or a live game video that plays at least a predetermined image and the voice of the distributing user, or it may be a superimposed display of a character object, or a real image of the distributing user, on these images.

Further, when the distributing user is included in a real space, a character object generated based on movement of the distributing user may be superimposed and displayed on the actual image of the distributing user. Further, an animation such as a gift object may be superimposed and displayed on a captured image of the real space.

### System Configuration

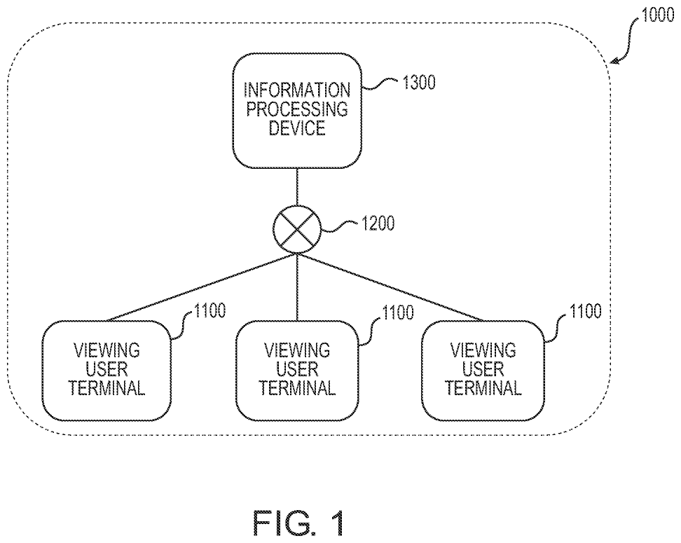

As shown as an example in FIG. 1, an information processing system 1000 according to this disclosure includes (i) one or more viewing user terminals 1100, and (ii) an information processing device (support computer) 1300 arranged in a video distribution studio or the like, which is connected to these viewing user terminals 1100 via a network 1200.

Further, the information processing device 1300 may be connected to a predetermined server device via the Internet, and part or all of the processing to be performed by the information processing device 1300 may be performed by the server device. The server device may be an information processing device 2400 shown in FIG. 2.

In this specification, distribution by the information processing system 1000 is referred to as studio distribution.

In studio distribution, movement of an entire body of a distributing user (actor) will be reflected in a character in real time by shooting markers attached to the distributing user with a camera(s) installed in the studio and using known motion capture technology.

Additionally, the information processing system 1000 can also work in cooperation with another information processing system 2000, shown in FIG. 2 as an example. The information processing system 2000 shown in FIG. 2 can include (i) a distributing user terminal 2100, (ii) one or more viewing user terminals 2200, and (iii) and an information processing device (server device) 2400 that is connected to the distributing user terminal 2100 and the viewing user terminals 2200 via a network 2300.

In the above example, the distributing user terminal 2100 can be an information processing terminal such as a smartphone. In this specification, distribution by such information processing system 2000 is referred to as mobile distribution.

In mobile distribution, the movement of the distributing user's face is captured by a camera provided in the distributing user terminal 2100 and reflected on the character's face in real time using known face tracking technology.

There is no particular distinction between a distributing user and a viewing user in mobile distribution. A viewing user can perform mobile distribution at any time, and a distributing user can be a viewing user when viewing a video of another distributing user.

The video generated by the information processing system 1000 and the information processing system 2000 can be distributed to a viewing user from one video distribution platform, as an example.

Furthermore, in any distribution, the process of generating animation by reflecting motion on a character, the process of displaying a gift described below, and the like may be shared by a distributing user terminal, a viewing user terminal, an information processing device and other devices.

That is, “distribution” here refers to sending information to make the video available for viewing at the viewing user terminal. Video rendering is performed at the information processing devices 1300, 2400 side or at the distributing user terminal 2100 and viewing user terminal 1100 and 2200 side.

Specifically, face motion data and sound data of the distributing user is sent from the distributing user terminal or information processing device to a terminal or device that generates (renders) an animation of a character object. Further, body motion may be sent in addition to the face motion.

In this disclosure, the process of generating an animation will be described as being performed by each of the distributing user terminal and the viewing user terminal, but this disclosure is not limited to this.

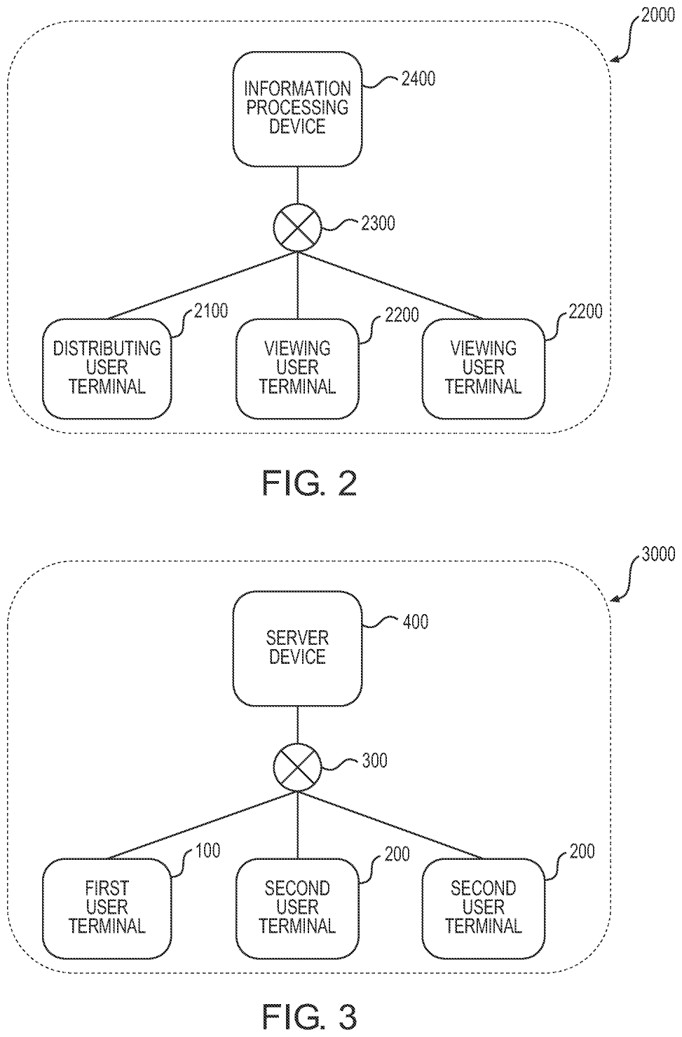

The information processing system in this disclosure can be applied to any of the examples shown in FIGS. 1 and 2. Further, an information processing system 3000 in an embodiment of this disclosure is described as being provided with a first user terminal 100, second user terminals 200, and a server device 400 that can be connected to these distributing first terminal 100 and second user terminals 200 via a network 300, as shown in FIG. 3.

The first user terminal 100 and the second user terminals 200 are interconnected with the server device 400 via, for example, a base station, a mobile communication network, a gateway, and the Internet. Communication is performed between the first user terminal 100 and the second user terminals 200 and the server device 400 based on a communication protocol such as the Hypertext Transfer Protocol (HTTP). Additionally, between the first user terminal 100 and the second user terminals 200 and the server device 400, communication may be performed based on WebSocket, which initially establishes a connection via HTTP communication and then performs bidirectional communication at a lower cost (less communication load and processing load) than HTTP communication. The communication method between the first user terminal 100 and the second user terminals 200 and the server device 400 is not limited to the method described above, and any communication method technology may be used as long as it can realize this embodiment.

The first user terminal 100 functions as at least the information processing device 1300, the viewing user terminal 1100, the distributing user terminal 2100, or the viewing user terminal 2200 described above. The second user terminals 200 function as at least the information processing device 1300, the viewing user terminal 1100, the distributing user terminal 2100, or the viewing user terminal 2200 described above. The server device 400 functions as at least the server device or information processing device 2400 described above.

In this disclosure, the first user terminal 100 and the second user terminals 200 may each be a smartphone (multi-functional phone terminal), a tablet terminal, a personal computer, a console game machine, a head-mounted display (HMD), a wearable computer such as a spectacle-type wearable terminal (AR glasses or the like), or an information processing device other than these devices that can reproduce a video. Further, these terminals may be stand-alone devices that operate independently, or may be constituted by a plurality of devices that are connected to each other so as to be able to send and receive various data.

### Hardware Configuration

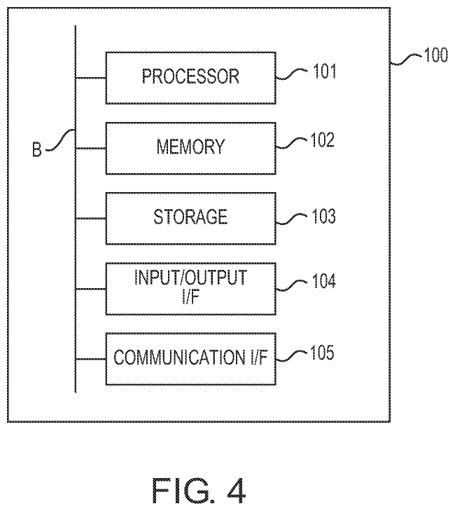

Here, a hardware configuration of the first user terminal 100 will be described using FIG. 4. The first user terminal 100 includes a processor 101, a memory 102, a storage 103, an input/output interface (input/output I/F) 104, and a communication interface (communication I/F) 105. Each component is connected to each other via a bus B.

The first user terminal 100 can realize the functions and methods described in this embodiment by the processor 101, the memory 102, the storage 103, the input/output I/F 104, and the communication I/F 105 working together.

The processor 101 executes a function and/or a method realized by a code or a command included in a program stored in the storage 103. The processor 101 may realize each process disclosed in each embodiment by a logic circuit (hardware) or a dedicated circuit formed in an integrated circuit (IC (Integrated Circuit) chip, an LSI (Large Scale Integration)) or the like, including, for example, a CPU (Central Processing Unit), an MPU (Micro Processing Unit), a GPU (Graphics Processing Unit), a microprocessor, a processor core, a multiprocessor, an ASIC (Application-Specific Integrated Circuit), an FPGA (Field Programmable Gate Array), or the like. These circuits may be realized by one or more integrated circuits. A plurality of processes shown in each embodiment may be realized by a single integrated circuit. Furthermore, LSI may also be referred to as VLSI, Super LSI, Ultra LSI, or the like, depending on difference in the degree of integration.

The memory 102 temporarily stores a program loaded from the storage 103 and provides a work area to the processor 101. Various data generated while the processor 101 is executing the program are also temporarily stored in the memory 102. The memory 102 includes, for example, a RAM (Random Access Memory), a ROM (Read Only Memory), and the like.

The storage 103 stores the program. The storage 103 includes, for example, an HDD (Hard Disk Drive), an SSD (Solid State Drive), a flash memory, or the like.

The communication I/F 105 is implemented as hardware such as a network adapter, software for communication, or a combination thereof, and is used to send and receive various types of data via the network 300. This communication may be executed by either by wire or wirelessly, and any communication protocol may be used as long as mutual communication can be executed. The communication I/F 105 executes communication with another information processing device via the network 300. The communication I/F 105 sends various data to other information processing devices according to instructions from the processor 101. The communication I/F 105 also receives various data sent from other information processing devices and transmits them to the processor 101.

The input/output I/F 104 includes an input device for inputting various operations to the first user terminal 100 and an output device for outputting processing results processed by the first user terminal 100. The input/output I/F 104 may be such that the input device and the output device are integrated, or may be separated into the input device and the output device.

The input device is realized by any one of all types of devices that can receive an input from a user and transmit information related to the input to the processor 101, or a combination thereof. The input device includes, for example, (i) a hardware key, such as a touch panel, a touch display, or a keyboard, (ii) a pointing device, such as a mouse, (iii) a camera (operation input via an image), and (iv) a microphone (operation input by sound).

The input device may include a sensor portion. The sensor portion is one or more sensors that detect (i) face motion, which indicates changes in the user's facial expression, and (ii) body motion, which indicates changes in the relative position of the user's body with respect to the sensor portion. Face motion includes movements such as blinking of the eyes, opening and closing of the mouth, and the like. A known device may be used as the sensor portion. An example of a sensor portion includes (i) a ToF sensor that measures and detects the time of flight (Time of Flight) until light irradiated toward the user is reflected by the user's face and returns, or the like, (ii) a camera that captures the user's face, and (iii) an image processor that image-processes the data captured by the camera. The sensor portion may also include an RGB camera for capturing visible light and a near-infrared camera for capturing near-infrared light. The RGB camera and near-infrared camera may use, for example, “True Depth” of the “iphone X (registered trademark),” “LIDER” of the “iPad Pro (registered trademark),” or other ToF sensors in smartphones. This camera specifically projects tens of thousands of invisible dots onto the user's face and the like. Then, accurate face data is captured by detecting and analyzing the reflected light of the dot pattern to form a depth map of the face and capturing infrared images of the face and the like. An arithmetic processor of the sensor portion generates various types of information based on the depth map and infrared images, and compares this information with registered reference data to calculate the depth (distance between each point and the near-infrared camera) and non-depth positional deviations for each point on the face.

Further, the sensor portion may have a function of tracking not only the user's face, but also the hand(s) (hand tracking). The sensor portion may further include a sensor other than the above-mentioned sensors such as an acceleration sensor and a gyro sensor. The sensor portion may have a spatial mapping function of (i) recognizing an object in the real space in which the user exists based on the detection results of the above ToF sensor or other known sensor, and (ii) mapping the recognized object to a spatial map. Hereinafter, when the face motion detection data and the body motion detection data are described with no particular distinction, they are simply referred to as “tracking data.” The image processor of the sensor portion may be provided with a controller that can be provided in the information processing system.

As an operation portion as an input device, a device corresponding to the type of the user terminal can be used. An example of the operation portion is a touch panel integrated with a display, an operation button provided on a housing of a user terminal, a keyboard, a mouse, a controller operated by a user, and the like. The controller may incorporate various known sensors such as an inertial measurement sensor (IMU: Inertial Measurement Unit) such as an acceleration sensor and a gyro. Furthermore, another example of the operation portion may be a tracking device that specifies the movement of the user's hand, the movement of the eyes, the movement of the head, the direction of the line of sight, and the like. In this embodiment, for example, based on the user's hand movements, the user's instructions are determined and various operations are performed such as starting or ending the video distribution, rating messages and videos, and requesting the display of predetermined objects (for example, the gift described below), and the like. If the sensor portion also has an input interface function such as a hand tracking function, the operation portion can be omitted.

The output device outputs the processing result processed by the processor 101. The output device includes, for example, a touch panel, a speaker, and the like.

The functions realized by the components described in this specification may be implemented in circuitry or processing circuitry programmed to realize the functions described, including general-purpose processors, special-purpose processors, integrated circuits, ASICs (Application Specific Integrated Circuits), a CPU (a Central Processing Unit), conventional circuits, and/or combinations thereof. Processors include transistors and other circuits, and are referred to as circuitry or processing circuitry. The processors may be programmed processors that execute programs stored in memory.

In this specification, circuitry, units, and means are hardware that is programmed, or hardware that performs, so as to realize the functions described. Such hardware may be any hardware disclosed in this specification or any hardware known to be programmed or to perform so as to realize the functions described herein.

When the hardware is a processor considered to be of the circuitry type, the circuitry, means or units are a combination of (i) hardware and (ii) software used to constitute a processor and/or the hardware.

Also, except for special cases, a second user terminal 200 and server device 400 in this disclosure can be configured with the same hardware configuration as in FIG. 4.

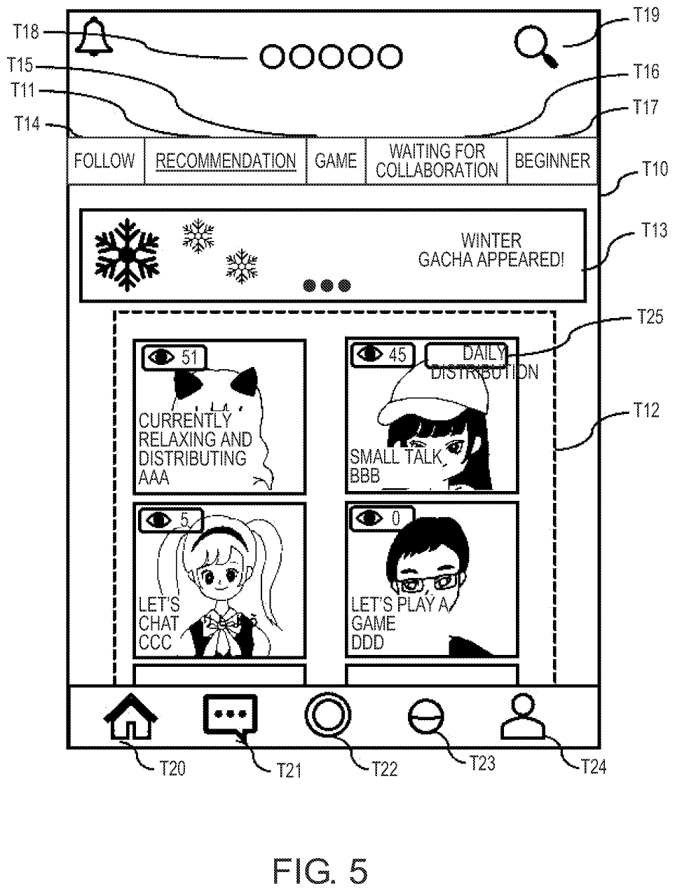

Next, various functions that can be executed in a user terminal that starts an application realized by an information processing system according to the embodiment of this disclosure, and transitions of screens that are displayed, will be described with reference to the drawings. FIG. 5 shows a top screen T10 displayed on a user terminal (here, it is not yet specified whether or not the user will view or distribute) when a video distribution/viewing application is started.

As shown in FIG. 5, by selecting one distribution channel (called a distribution frame, distribution program, distribution video or the like) from among thumbnail images of one or more recommended distribution channels T12 displayed in a recommendation tab T11 on the top screen T10, the user can view a video played on that distribution channel.

Alternatively, by accessing a fixed link for a specific distribution channel, the user can view a video played on that specific distribution channel. Such fixed links may come from a notification from a first user who is followed, or from a share notification sent by another user. Here, the user who views the video is the viewing user, and the terminal for viewing the video is the second user terminal 200.

Further, as shown in FIG. 5, a display field T13 for notification of a campaign, an event, or the like may be displayed on the top screen T10. The display field T13 of this notification can be switched to another notification by a slide operation.

Additionally, from the top screen T10, a follow tab T14, a game tab T15 for displaying a game category, an awaiting collaboration tab T16 for displaying a distribution channel that is awaiting collaboration, and a beginner tab T17 for displaying a beginner's distribution channel are displayed. By selecting these (by switching the tabs), the top screen T10 transitions to respective different screens.

A service name display T18 and a search button T19 in an upper frame of the top screen T10 may be fixedly displayed on a transition destination screen.

Similarly, a home button T20, a message button T21, a distribution preparation button T22, a gacha button T23, and a profile button T24 in a lower frame of the top screen T10 may be fixedly displayed on the transition destination screen.

A user who selects displayed thumbnail images T12 on the top screen T10 or the like shown in FIG. 5 becomes a viewing user (second user) who views the video as described above, and a user who selects the distribution preparation button T22 can become a distributing user (first user) who distributes a video.

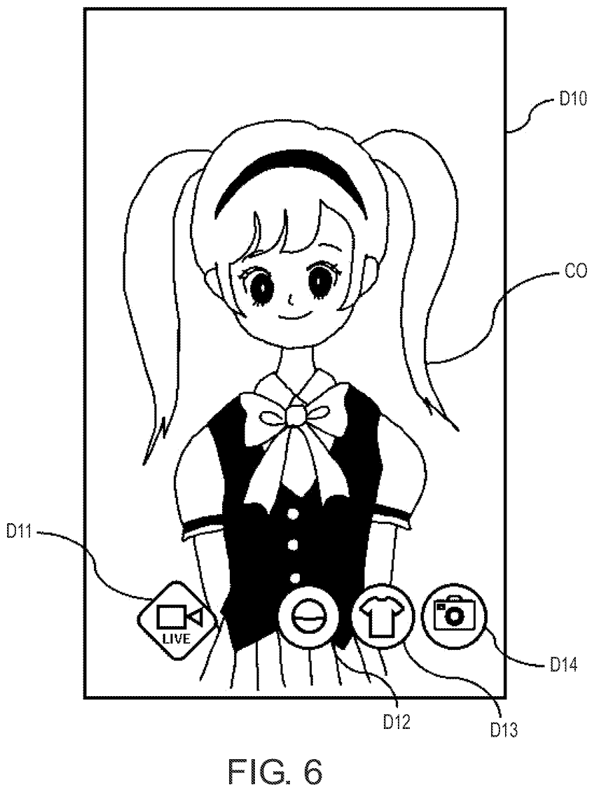

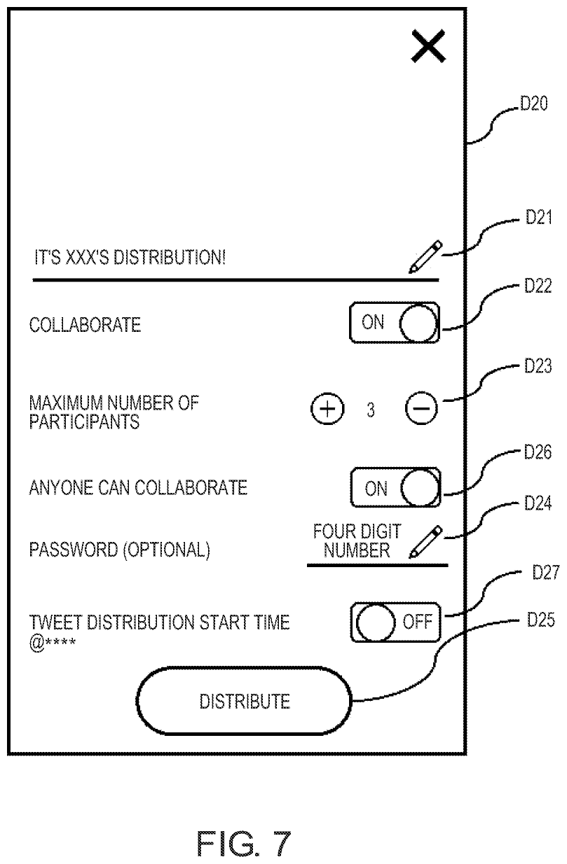

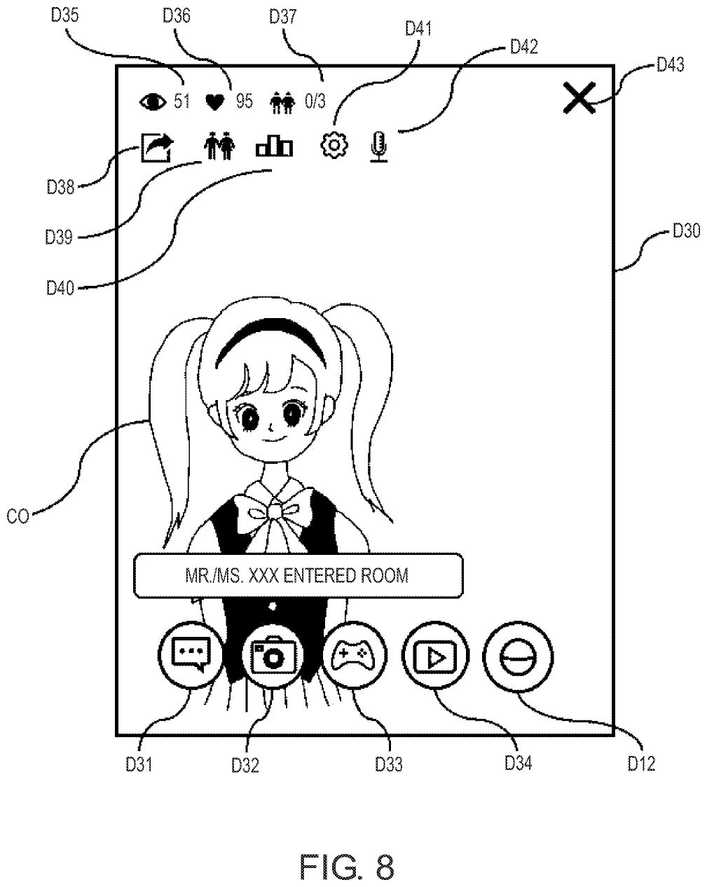

As an example, when the distribution preparation button T22 is selected on the top screen T10 shown in FIG. 5, the screen transitions to an avatar setting screen D10 shown in FIG. 6. Then, when a distribution button D11 is selected on the avatar setting screen D10, the screen transitions to a distribution setting screen D20 shown in FIG. 7. Then, when a distribution start button D25 is selected on the distribution setting screen D20, the screen transitions to an avatar distribution screen D30 shown in FIG. 8.

Next, details of a flow up to the start of video distribution will be described.

The one or more computer processors in this disclosure may include a distribution start request receiver, a distribution setting portion, and a distribution start portion.

The distribution start request receiver receives a distribution start request for a first video including an animation of a character object from the first user terminal of the first user.

Here, the first video refers to a video including an animation of a character object. In this specification, the character object may be referred to as an “avatar.”

The above-described distribution start request can be sent from the user terminal to the information processing device 400 by selecting the distribution button D11 located on the avatar setting screen or the like that has transitioned from the top screen displayed on the user terminal (later to become the first user terminal) that started a dedicated application (video distribution/viewing application) for accessing the above-described video distribution platform. FIG. 6 shows an example of the avatar setting screen D10. A character object CO, the distribution button D11, a gacha button D12, a clothes-changing button D13, a photo button D14, and the like can be displayed on the avatar setting screen D10.

When the clothes-changing button D13 is selected by the user, a closet screen for selecting various avatar parts such as eyes, nose, mouth, hair, accessories, clothes, and background of the character object CO appears.

When the gacha button D12 is selected by the user, a lottery screen for obtaining the above-described avatar parts appears.

When the photo button D14 is selected by the user, a capturing screen for capturing a still image of the character object appears.

When the distribution button D11 is selected by the user, a distribution start request is sent to the information processing device 400.

The distribution setting portion sets the distribution setting of the first video based on the designation from the first user terminal 100 in response to the distribution start request of the first video received by the distribution start request receiver.

As an example, when the distribution button D11 is selected, the screen displayed on the first user terminal 100 transitions from the avatar setting screen D10 shown in FIG. 6 to the distribution setting screen D20 shown in FIG. 7.

The distribution setting can include at least one of a setting related to the title of the first video, a setting regarding whether other users can appear in the first video, a setting related to the number of people who can appear in the first video, or a setting related to a password.

These distribution settings can be set in a title setting field D21, a collaboration possibility setting field D22, a number-of-people setting field D23, and a password setting field D24 in FIG. 7, respectively. Additionally, in FIG. 7, an anyone-can-collaborate possibility setting field D26 and an SNS posting possibility field D27 are further displayed.

The title of the first video can be freely determined by the distributing user within a range of a number of characters up to an allowable upper limit. If there is no input by the distributing user, a preset title, including the name of the character object (distributing user) such as “This is so and so's distribution [symbol] ,” may be determined automatically.

Whether other users can make a request for appearance in the first video can be freely determined by the first user. If yes, other users can make a request for appearance to the distributing user. If no, other users cannot make a request for appearance to the distributing user. A state in which another user appears in the video of the first user may be referred to as “collaboration” in this specification. Details of the collaboration will be described later.

The number of people who can appear in the first video can be set only when other users can appear in the first video mentioned above, and the distributing user can freely determine this number within a range of the number of people up to an allowable upper limit.

A password can be arbitrarily set only when other users can appear in the first video mentioned above, and the distributing user can freely determine the designated number of digits. When another user makes a request for appearance in the first video, entering of such a password is required. A configuration is acceptable in which the password setting field D24 may become active only when the anyone-can-collaborate possibility setting field D26 is OFF.

The distribution start portion distributes information about the first video to the viewing user terminal(s) 200 of the viewing user(s) based on the conditions set by the distribution setting portion.

The instruction to start such distribution is sent by selecting the distribution start button D25 shown in FIG. 7.

As an example, the distribution start portion distributes information about the video (first video) including the animation of the character object of the first user to the second user terminal 200 of the second user (avatar distribution).

Information about the first video includes, for example, motion information indicating movement of the character object, sound information of the first user, and gift object information indicating a gift sent from another viewing user. The gift object information includes at least gift object identification information that specifies the type of the gift object and position information that indicates the position where the gift object is to be displayed.

Then, the distribution start portion can live-distribute the video via the video distribution platform described above.

FIG. 8 shows the avatar distribution screen D30 displayed on the first user terminal 100.

In addition to displaying the character object CO on the avatar distribution screen D30, a comment input button D31 for the distributing user to input a comment, a photo button D32 for saving a still image of the screen, a play start button D33 for playing a game described later, an external service liaison button D34 for viewing a video provided by an external service, and the gacha button D12 for obtaining an avatar part can be displayed.

Additionally, a cumulative number-of-viewers display D35, a cumulative number-of-likes display D36, a number-of-collaborators display D37, a share button D38 for an external SNS, a guest details button D39, a ranking display button D40, a setting button D41, and a sound switching button D42 for switching sound ON/OF can be displayed. Further, an end button D43 for ending the distribution is also displayed.

Although detailed description of these displays and buttons is omitted, it is possible to change the distribution settings set on the distribution setting screen D20 by selecting the setting button D41.

FIG. 8 shows an example of starting distribution in which the distribution setting screen D20 allows other users to appear in the first video, and the number of people who can appear in the first video is three. Therefore, the character object CO is displayed in a state of being closer to the lower left. This is a state in which up to three character objects of other users are able to appear in a vacant space.

The above is a description of the screen transition when the avatar distribution of this disclosure is performed.

Subsequently, a screen transition when the distributing user plays a game during distribution will be described.

The one or more computer processors in this disclosure may include a game request receiver, a game video distribution portion, and a game display processor.

The distributing user can request to start playing a game by selecting the play start button D33 during avatar distribution such as is shown in FIG. 8.

The game displayed by selecting the play start button D33 can be a dedicated game implemented in the application realized by the information processing system in this disclosure, and can be different from a general-purpose game provided by an external service. Therefore, the game distribution in this disclosure may be distinguished from the distribution of a general-purpose game play video provided by an external service together with a live broadcast of the distributing user.

Alternatively, the play start request may be sent from the first user terminal 100 to the information processing device 400 by selecting the play start button arranged on a predetermined screen displayed on the first user terminal 100 of the first user.

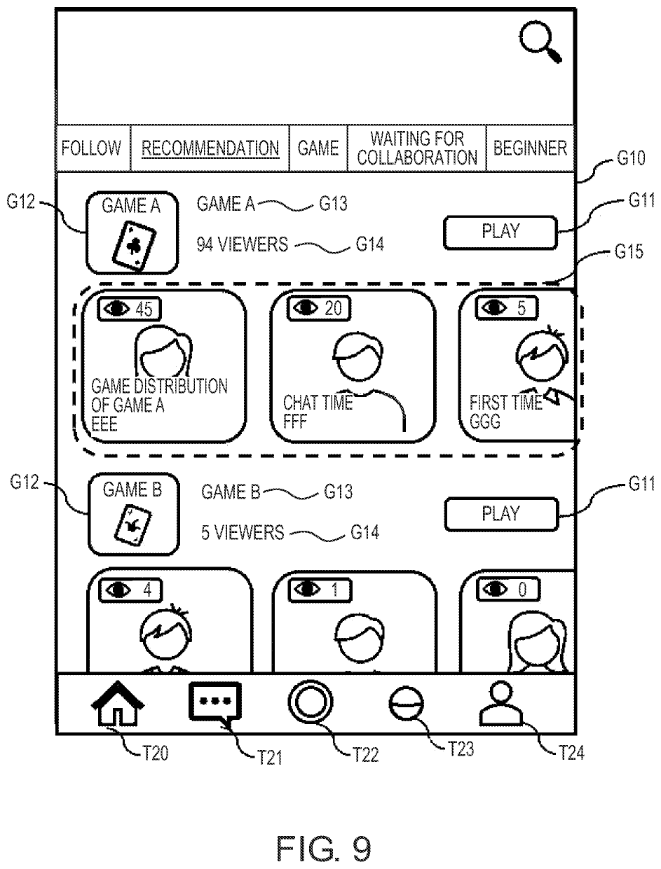

FIG. 9 shows an example of a screen G10, in which a play start button G11 is arranged, as the predetermined screen. The screen G10 shown in FIG. 9 is a screen that has transitioned from the top screen T10 (FIG. 5) displayed on a user terminal that has started the application realized by the information processing system in this disclosure by selecting the game tab T15. At least the play start button G11 that can send a request to start play of a predetermined game is displayed on the screen G10.

Then, when the game request receiver receives the request to start play of the predetermined game, the game video distribution portion distributes information about a second video to the second user terminal 200.

Here, the second video is a play video of a predetermined game. In this specification, distributing a video so that it is displayed on the screen of the second user terminal 200 is called “game distribution.”

Further, as a first user, after starting the application realized by this disclosure, the user can send the request for the start of distribution of the second video to the information processing device 2400 by selecting a play start object arranged on the game list screen and the game detail screen.

The game list screen or the game details screen is a first screen to be described in detail below.

That is, the game display processor performs display processing of the first screen including (i) a distribution start object that can send a distribution start request, (ii) a play start object that can send a play start request for a predetermined game, and (iii) a thumbnail image of a video that is distributing a play video for a predetermined game.

The screen G10 shown in FIG. 9 corresponds to the game list screen of the first screen. The first screen, which is the game list screen, is a screen that has transitioned from the top screen T10 by selection of the game tab T15.

The first screen includes (i) the distribution preparation button T22 as a distribution start object, (ii) the play start button G11 as a play start object, and (iii) a thumbnail image showing a distribution channel of a video.

On the first screen, for each of a plurality of playable games, the play start button G11, a game icon G12, a game name G13, a total number-of-viewers G14 of the distribution channel of the game, and a distribution list G15 including thumbnail images of the distribution channels during the game distribution are displayed.

The order of the thumbnail images displayed in the distribution list G15 displayed here may be different depending on the viewing user. As an example, the thumbnail images are arranged in the order of (i) the order in which the number of viewing users following and the number of views by those viewing users are highest, (ii) the order in which the cumulative number of viewers is highest, and (iii) the order in which the distribution start is oldest. Additionally, the display range of the thumbnail images of the distribution list G15 can be changed by horizontal scrolling.

Additionally, the games displayed on this game list screen will read the top 10 titles with the following priorities. As an example, the priority is determined by (i) the order by newest date within 48 hours from the game distribution start date and time, and in which a viewing user last played within 30 days, (ii) the order of highest priority of a period ID, and (iii) the descending order of the period ID.

This distribution list G15 will be updated (i) when returning from the screen of another tab and (ii) when a refresh operation (Pull-to-Refresh) has been performed.

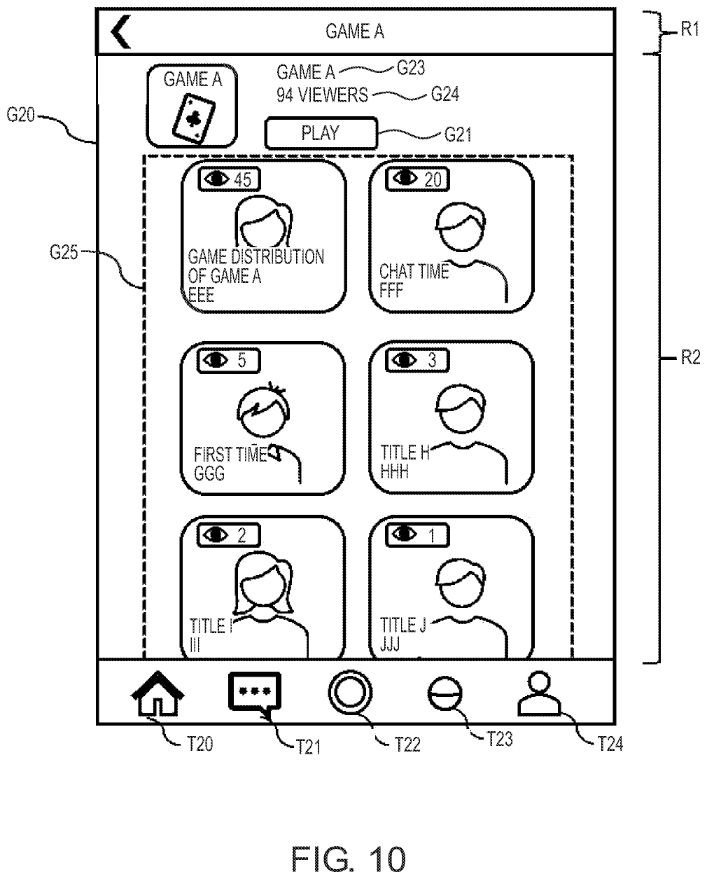

FIG. 10 corresponds to a game detail screen of the first screen. The first screen, which is the game detail screen, is a screen that has been transitioned to by selecting a game icon G12 or a game name G13 displayed on the game list screen shown in FIG. 9, and is G20.

The first screen includes the distribution preparation button T22 which is a distribution start object, a play start button G21 which is a play start object, and thumbnail images showing video distribution channels.

Further, on the first screen, a game icon G22, a game name G23, a total number-of-viewers G24 of the distribution channel of the game, and a distribution list G25 including thumbnail images of the distribution channels that are distributing the game are displayed.

The order of the thumbnail images displayed in the distribution list G25 displayed here may be different depending on the viewing user. As an example, the order is arranged in the order of (i) the order in which the number of viewing users following and the number of views by the viewing users is highest, (ii) the order in which the cumulative number of viewers is highest, and (iii) the order in which the distribution start is oldest. Additionally, the display range of the thumbnail images of the distribution list G25 can be changed by vertical scrolling.

This distribution list G25 will be updated (i) when returning from the screen of another tab and (ii) when a refresh operation (Pull-to-Refresh) has been performed.

As described above, a user who selects the distribution start object or the play start object becomes a first user who makes the distribution start request or the play start request.

Further, a user who selects a thumbnail image becomes a second user who views the second video.

In addition, the first screen includes a first region in which a scrolling operation is not possible, and a second region in which a scrolling operation is possible.

The first screen referred to here is the first screen shown in FIG. 10. The first screen includes a first region R1 and a second region R2. Specifically, the game title is displayed in the first region R1, and the play start button G21, the game icon G22, the game name G23, the number of viewers G24, and the distribution list G25 described above are displayed in the second region R2.

The first region R1 is a portion in which a scrolling operation is not possible, and is fixedly displayed on the display screen, and the second region R2 is a portion in which a scrolling operation by the user is possible. By scrolling the second region R2, the user can check the thumbnail images hidden outside the screen.

However, since the play start button G21 may be hidden outside the screen by scrolling in the second region, the display processor in this disclosure can display a play start object (play start button G21) in the first region R1 according to a display state of a play start object (play start button G21) displayed in the second region R2.

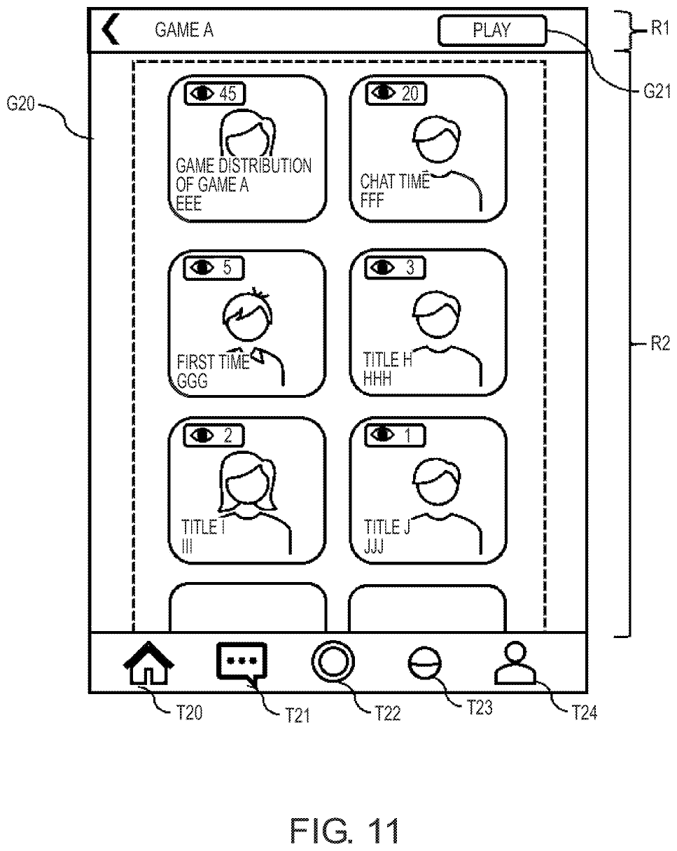

As an example, in FIG. 10, the play start button G21 is displayed in the second region R2, but in FIG. 11, it is displayed in the first region R1. That is, when part or all of the play start button G21 is not displayed in the second region R2, the play start button G21 appears in the first region.

Further, the game display processor may display the play start object in the first region R1 in stages according to the display state of the play start object displayed in the second region R2.

Such an expression can be realized by changing the transparency of the play start object according to the scroll amount of the second region R2.

As an example, a scroll amount (unit is pixels) of 0 to 50 is caused to correspond to a button transparency of 0.0 (completely transparent) to 1.0 (completely opaque). Thus, in the initial display state, the object is completely transparent and cannot be seen, and when scrolling by 50 pixels or more has been performed, the object is completely displayed. During that scrolling (0 to 50), it is preferable to change the transparency of the object linearly. The unit of the scroll amount is a logical pixel, which may be different from an actual pixel of the display.

Further, the game request receiver can accept a play end request for a predetermined game from the first user terminal 100 after the game video distribution portion distributes information about the second video.

The play end request can be sent by selection of an end button arranged on the game screen.

Then, when the game request receiver receives the play end request of the predetermined game, the video distribution portion can end the distribution of the information about the second video and distribute the information about the first video.

That is, what is distributed here is not part of the information of the first video, but all the information of the first video.

Then, when the video distribution portion ends the distribution of the information about the second video and distributes the information about the first video, what is displayed on the second user terminal 200 is the first video.

The following is an explanation of a flow to start viewing the video.

The one or more processors in this disclosure may further include a viewing receiver.

The viewing receiver receives a video viewing request from a user.

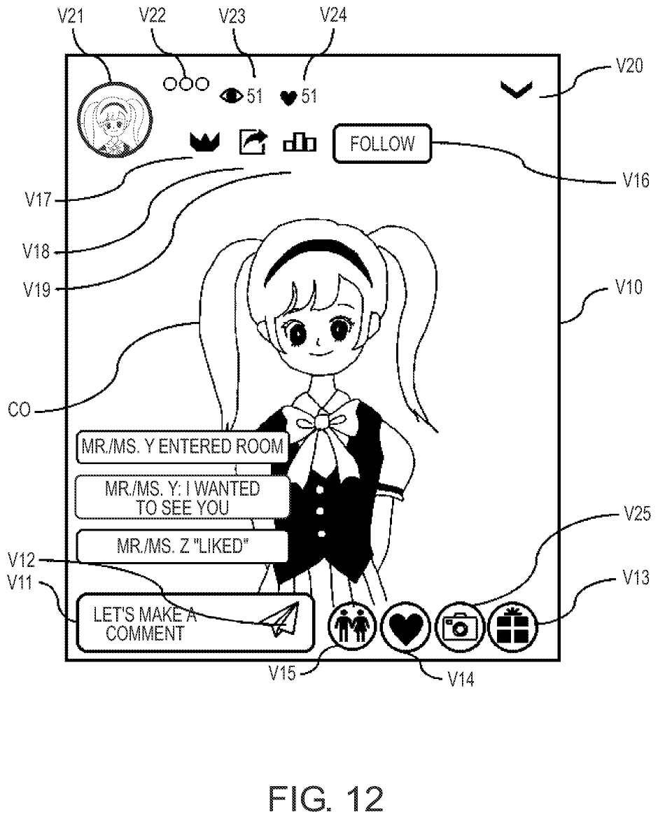

The video distribution portion distributes video and sound information as video information to the user's information processing terminal in response to the viewing request. FIG. 12 is an example showing a viewing screen V10 of an avatar video displayed on the second user terminal 200.

The viewing user can post a comment by inputting text in a comment posting field V11 and pressing a send button V12.

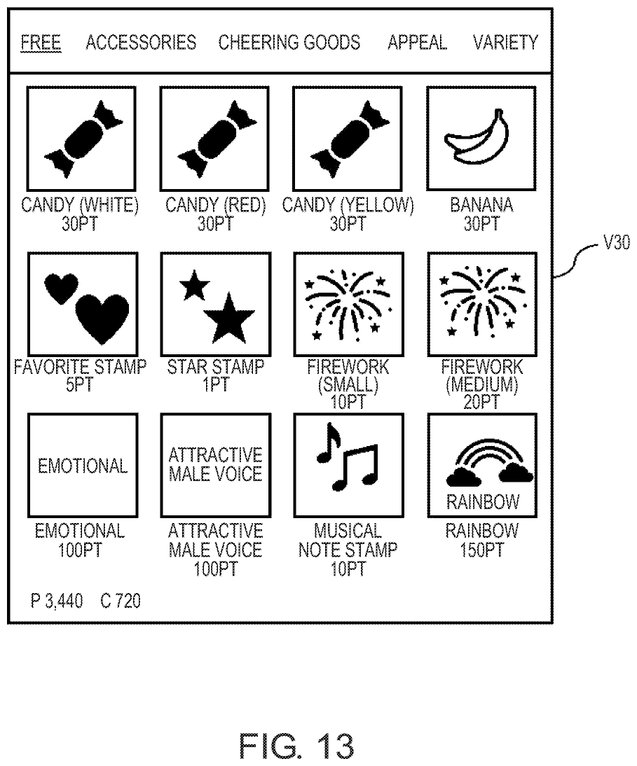

Further, by pressing a gift button V13, a gift list (screen V30 in FIG. 13) is displayed to the viewing user, and a display request for a gift designated by selection can be sent.

At this time, the one or more processors in this disclosure may include a determination portion. The determination portion determines whether there is a gift display request from the second user terminal 200.

The display request can include gift object information. The gift object information includes at least (i) gift object identification information that specifies the type of the gift object and (ii) position information that indicates the position where the gift object is to be displayed.

Further, as shown in FIG. 13, gifts can be displayed separately for each category (free (paid) gifts, accessories, cheering goods, appeal, variety, or the like).

Here, a paid gift is a gift (coin gift) that can be purchased by the consumption of “My Coin” purchased by the viewing user. A free gift is a gift (point gift) that can be obtained with or without consumption of “My Points,” which the viewing user has obtained for free.

The term “gift” used in this application means the same concept as the term “token.” Therefore, it is also possible to replace the term “gift” with the term “token” to understand the technology described in this application.

Furthermore, the viewing user can post a rating showing favor by pressing a like button V14. In addition to/in place of the like button V14, it is also possible to display a button for posting a negative rating or other emotions.

An object may be displayed in the video, in correspondence to this rating post. For example, when a favorable rating is posted, a heart mark or a thumbs-up mark can be displayed.

In addition, when the first user has enabled other users' appearances in the distribution settings, a user can send a request to appear in the video by selecting a collaboration request button V15.

In addition, a follow button V16 for a second user to follow a distributing user is displayed on the screen of a video distributed by a first user whom the second user has not yet followed. This follow button functions as an unfollow button on the screen of a video distributed by a first user whom a second user is already following.

This “follow” may be performed from a second user to another second user, from a first user to a second user, and from a first user to another first user. However, this “follow” is managed as a one-way association, and a reverse association is managed separately as a follower. Additionally, a photo button V25 for saving a still image of the screen can also be displayed.

Further, a cheering ranking display button V17, a share button V18, and a ranking display button V19 are also displayed on the viewing screen V10.

The cheering ranking displays the ranking of a second user who cheers a first user, and the ranking can be calculated according to the amount of gifts (points/coins) or the like.

Additionally, regarding the sharing of videos, by pressing the share button V18, the second user can check a list of SNS (Social Networking Services) that can be shared, and can send a fixed link to a designated location of the SNS designated by selection.

Furthermore, by pressing the collaboration request button V15, it is possible to request collaborative distribution from a first user. Collaborative distribution means that the character object of a second user is caused to appear in a distributed video of the first user.

At the top of the viewing screen V10, a distributing user icon V21, a distributing user name (character object name) V22, a cumulative number-of-viewers display V23, and a cumulative number-of-likes display V24 can be displayed.

Further, when the viewing end button V20 is selected, a screen for ending viewing appears, and a viewing end request can be sent.

The screen for ending such viewing will be described in detail. Such a screen is called “small window sound distribution,” and is for viewing a video in a manner of playing only the sound without displaying the image of the video.

The selection of the viewing end button V20 is accepted by the viewing receiver as a video viewing end request.

At this time, the video distribution portion ends the distribution of the image-related information in response to the viewing end request, but does not end the distribution of the sound-related information.

Thus, when the image- and sound-related information are distributed at the user terminal, the image is displayed on the main screen at the user terminal, and when only the sound information is distributed, the image is not displayed at the user terminal and a sub screen indicating that the video is being viewed is displayed.

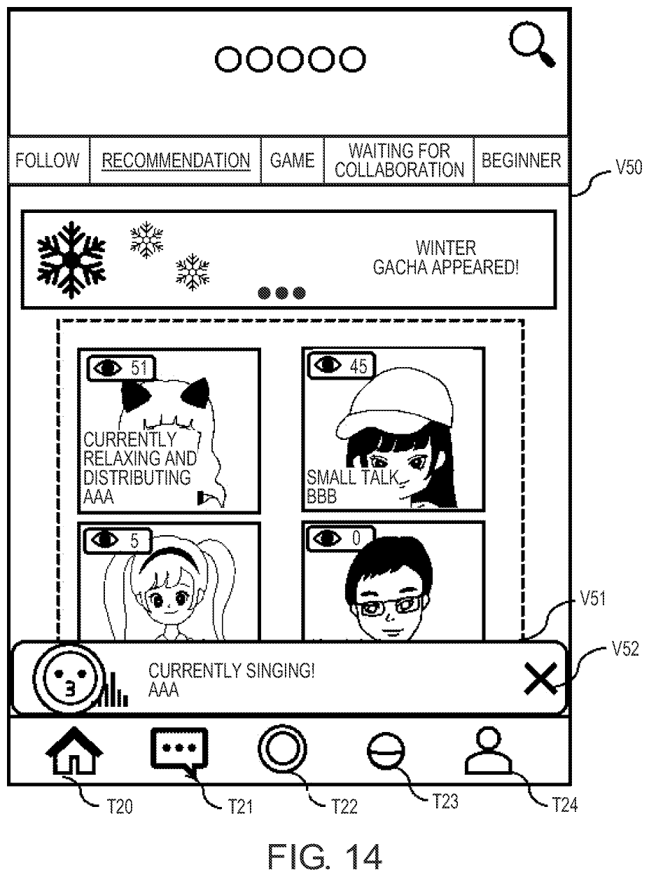

FIG. 14 shows an image of a screen V50 on which a sub screen V51 is displayed.

When this sub screen V51 is displayed, the main screen displayed at the back transitions to the screen before viewing the video. For example, when moving from a recommendation tab to the viewing frame, the display returns to the recommendation tab, and when moving from the follow tab to the viewing frame, the display transitions to the follow tab.

When this sub screen VS1 is being displayed, operation on the main screen becomes possible, and transition to another screen becomes possible.

On the sub screen V51, a profile image, a name, a title, and a sound icon that can visually identify that sound is playing are displayed.

Then, by selecting an end icon V52 displayed on the sub screen V51, the viewing can be completely ended.

Regarding the end of the display of the image, the information may be sent from the server device, but not displayed at the terminal side, or the transmission of the information itself from the server device may be stopped.

With such a configuration, it becomes possible to search for other distributions and enjoy chatting with other users while listening only to sound.

Next, a “collaboration” in which another user appears in the video of the first user will be described.

As described above, a second user can send a request to participate in the video via the confirmation screen of the collaborative distribution participation request, which is displayed by pressing the collaboration request button V15 shown in FIG. 12.

A collaboration avatar display portion provided to one or more computer processors in this disclosure causes a character object generated based on the movement of the viewing user who made the participation request to be displayed in the video, in response to the received participation request.

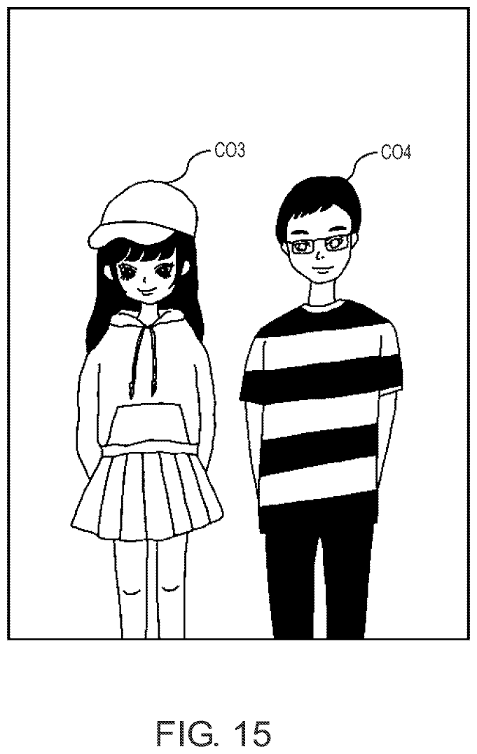

FIG. 15 shows, as an example, a viewing or distribution screen when a second avatar CO4, which is a character object of a guest user, participates in a video in which a first avatar CO3, which is the character object of the host user, is displayed. In FIG. 15, the display of objects other than the avatars is omitted.

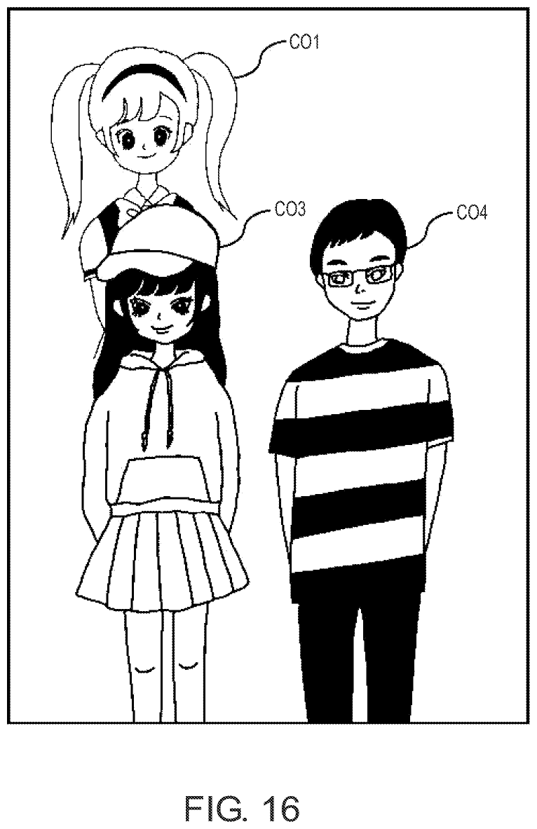

Further, as shown in FIG. 16, a third avatar CO1, which is a character object generated based on the movement of another viewing user, may participate in the video. Additionally, although the third avatar CO1 is arranged behind the first avatar CO3 and the avatar CO4 in FIG. 16, the three people may be arranged so as to line up in a horizontal row. Further, the arrangement position of the avatars may be designated by the distributing user.

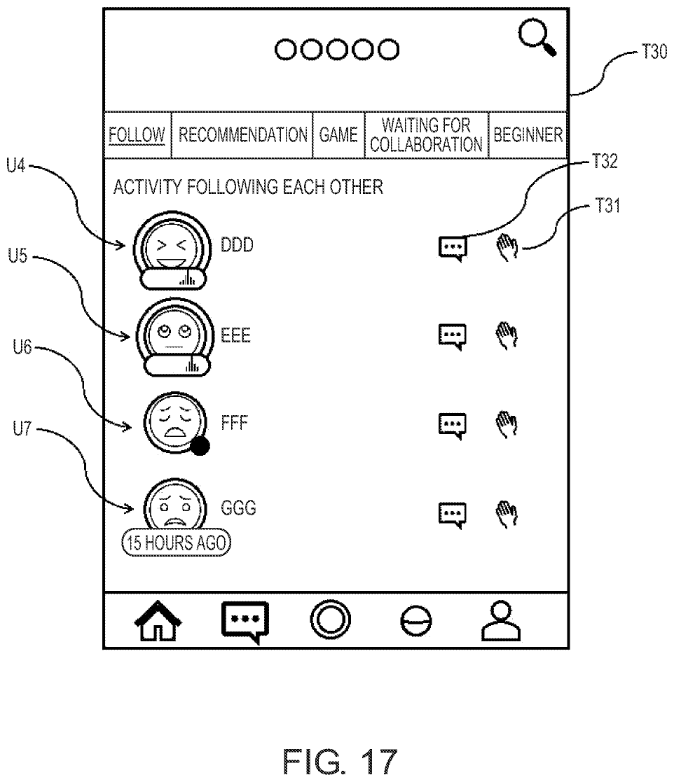

FIG. 17 shows a list screen T30 of users having a mutual follow relationship, which is displayed by selection of the follow tab on the top screen shown in FIG. 5. Mutual follow is a relationship in which each is a follower of the other.

On the list screen T30, profile images and names of users who have a mutual follow relationship are displayed.

As shown in FIG. 17, a first object T31 is displayed on the list screen T30 for each of the users having a mutual follow relationship. Further, a chat object T32 may be displayed together with the first object T31. By selecting this chat object, it is possible to transition to an individual chat screen with a second user.

Selection of the first object T31 sends a predetermined notification to the terminal of the user associated with the first object T31.

The predetermined notification may be, for example, a call notification.

Nest, a detailed description of a flow for executing a video chat in an embodiment of this disclosure will be explained.

As an example, a user can execute a video chat from an individual chat screen or a group chat screen.

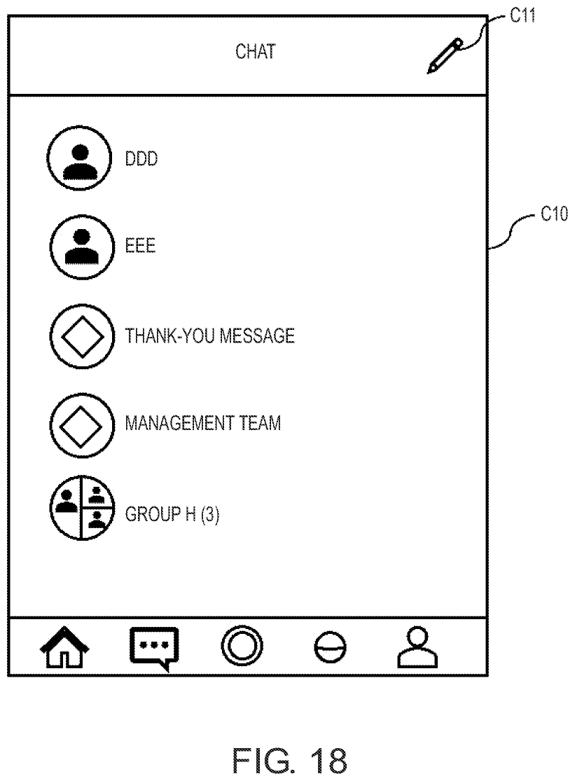

These chat screens can be transitioned to, for example, from a chat list screen C10 (FIG. 18) expanded by selecting the message button T21 on the top screen T10 (FIG. 5).

The chat list screen C10 shown in FIG. 18 displays icons of users (character objects) or icons of groups that have sent or received messages (chats) in the past, along with their names or titles. The icons of groups can include icons of users (character objects) participating in the groups.

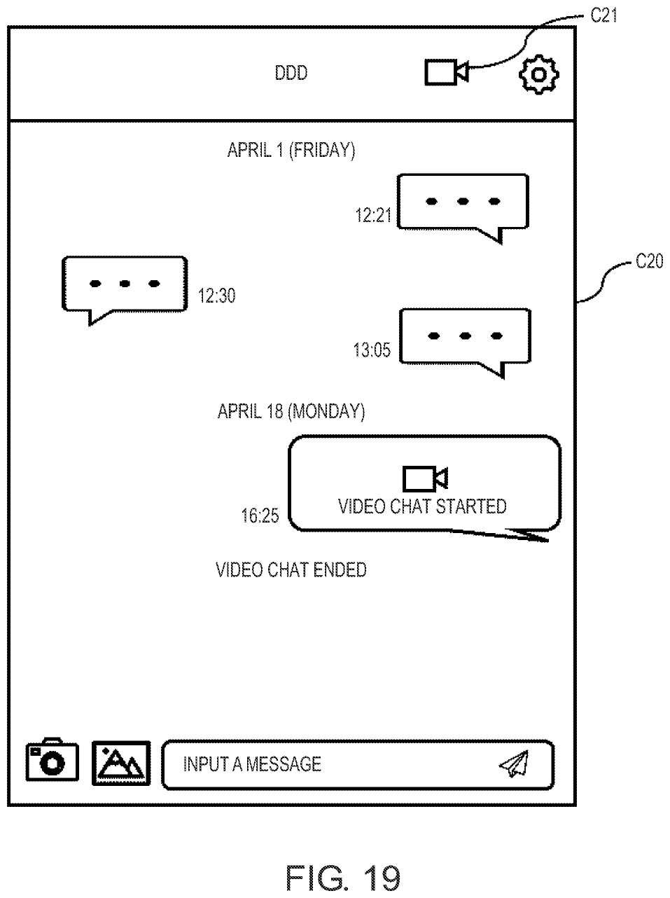

The user can then select one user or group on the above-described chat list screen C10, open an individual chat screen C20 (FIG. 19) or a group chat screen, and select a video chat button C21 to start a video chat.

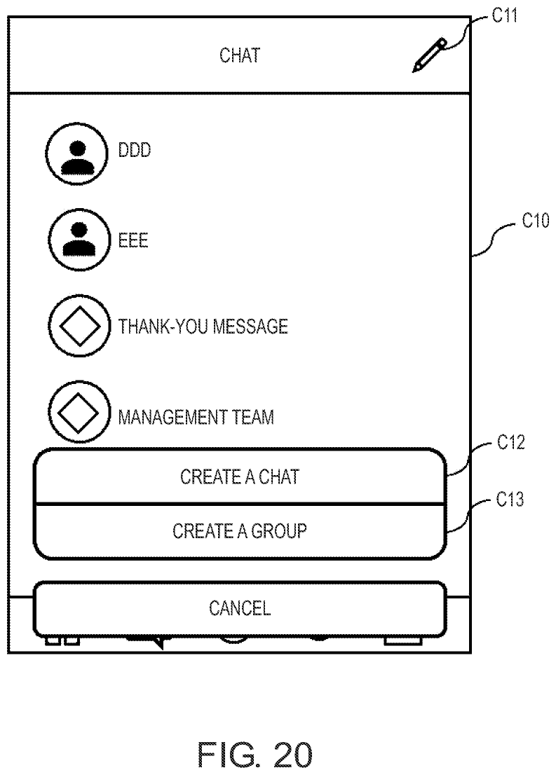

Additionally, by selecting a chat creation button C12 or a group creation button C13 displayed by selecting an edit button C11 on the chat list screen C10 (FIG. 20), a chat screen of a user or group not displayed on the chat list screen C10 can be created.

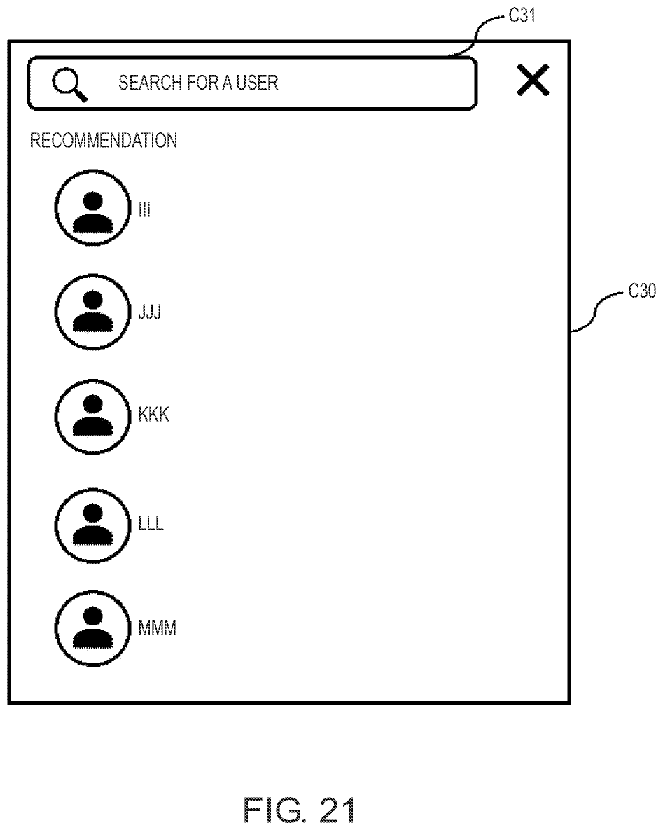

FIG. 21 is a user selection screen C30 that deploys when the chat creation button C12 is selected, and a chat screen with a recommended user(s) that is being displayed or a user searched for using a search field C31 is displayed/generated. A configuration of the generated chat screen is the same as the chat screen C20 shown in FIG. 19, and video chatting can be started by selecting the video chat button C21.

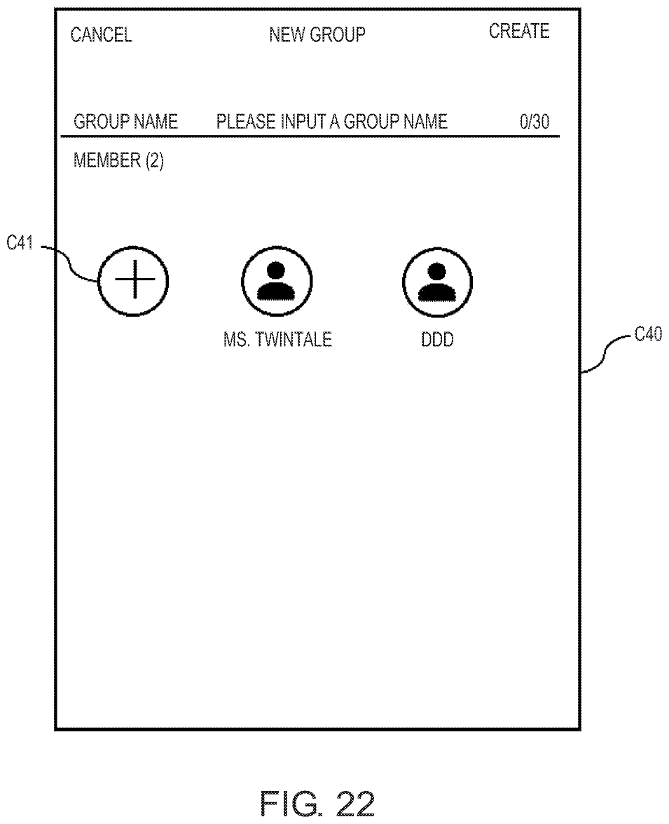

Similarly, FIG. 22 shows a group creation screen C40 that deploys when the group creation button C13 is selected. The user can add users other than himself/herself as group members by selecting a user addition button C41. As an example, the number of group members that can be added is up to 7. A group name can also be set on this screen.

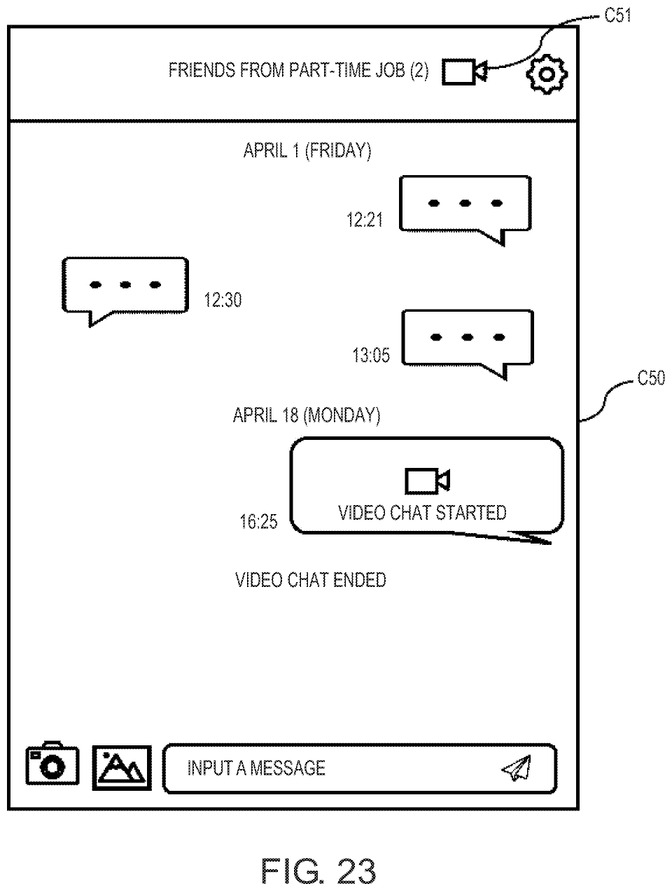

Once a group is created, a group chat screen C50 is displayed (FIG. 23). In the group chat screen C50 as well, video chatting can be started by selecting a video chat button C51. Furthermore, the above-described chat screen C20 can be transitioned to from the chat icon T32 of the list screen T30 (FIG. 17).

Also, a chat icon can also be arranged on a profile screen of another user, and the user can transition from various pages to a chat screen, and start a video chat.

When a video chat is started, a notification is sent to the other party, and the other party can participate in the video chat by responding to the notification. Users can set whether or not to receive such notifications.

Furthermore, the system may be configured to allow video chatting only with users who are in a mutual follow relationship. In this case, the system may be configured to display an icon on the follow list screen indicating that a user in a mutual follow relationship is in a video chat with another user, and a user may select the icon to participate in such an ongoing video chat.

The video chat in this disclosure can be said to be a function that allows only a specific user to view the collaborative distribution described above. The specific user here refers to a user participating in a video chat.

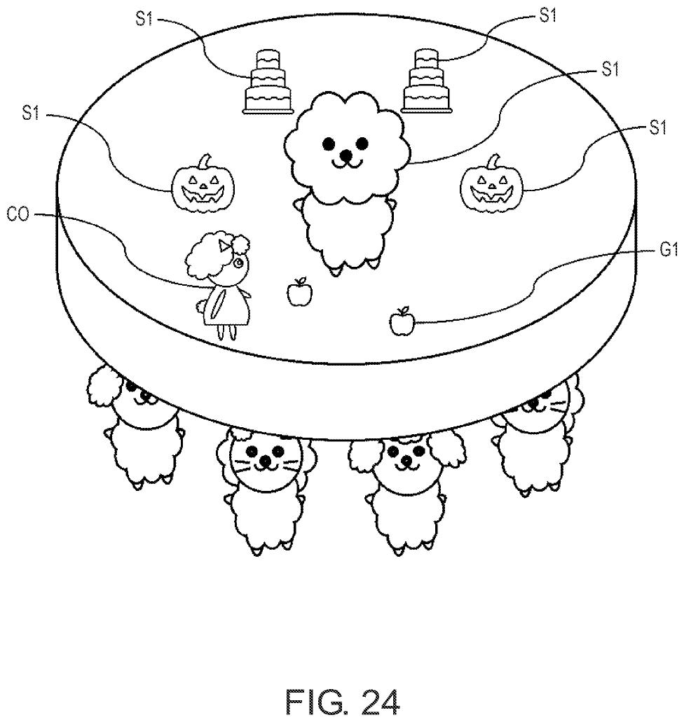

Next, an image of the spread of the virtual space in this disclosure will be described with reference to FIG. 24.

As shown in FIG. 24 as an example, the virtual space in this embodiment is arranged such that a disk-shaped island (world) is floating in the air. This island is an object in the form of a tower-shaped cake turned upside down, and can be configured such that various objects are arranged on a disk-shaped ground. The island and the ground are shown as an example, and the display mode thereof is not particularly limited.

The objects that can be displayed include at least the character object CO of a first user, a gift object G1 corresponding to a gift for which a display request was made by a second user, and an object S1, the display position and display timing of which are controlled by the server device 400 (system side).

The character object can be caused to move, jump, and the like within the world by user operation, and such functions can be provided as one of the games described above, for example. In this disclosure, this is specifically referred to as “world distribution” and the procedures for starting and ending game distribution described above apply.

Specifically, switching from normal distribution (avatar distribution) to world distribution can be performed by selecting the play start button D33 of a game displayed in the avatar distribution video (FIG. 8) or by selecting the play button G11 or G21 of one game selected from the game list displayed on the destination screen to which the user has moved by selecting the play start button D33 (FIG. 9, FIG. 10).

Also, switching from world distribution to avatar distribution can be performed by selecting a play end button displayed in a world distribution video.

Next, various functions executable in the information processing system 3000 according to an embodiment of this disclosure will be described with reference to the drawings.

The information processing system 3000 according to an embodiment of this disclosure can be, for example, an information processing system that provides a virtual space in which the character object of the user can be displayed.

The virtual space is not particularly limited as long as the space is one that can display the user's character object.

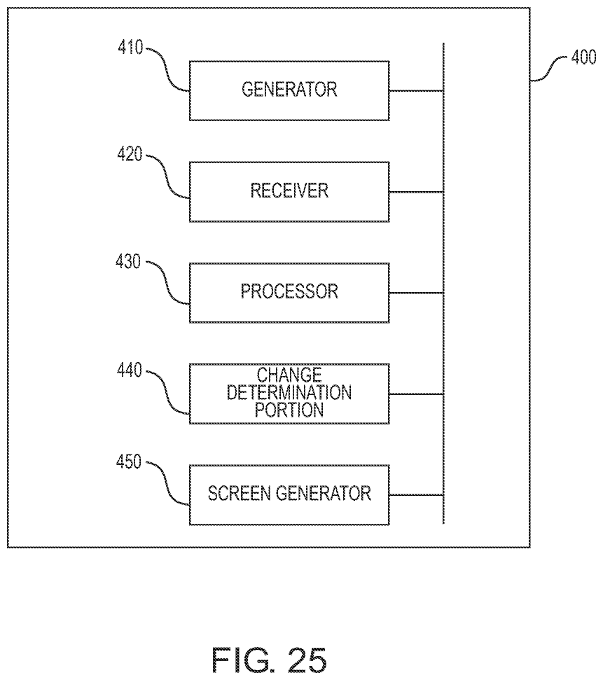

One or more computer processors included in the information processing system 3000 include a generator 410, a receiver 420, a processor 430, a change determination portion 440, and a screen generator 450, as shown in FIG. 25 as an example.

In the following description, the generator 410, the receiver 420, the processor 430, the change determination portion 440, and the screen generator 450 are all included in the server device 400, but this is intended to be illustrative and not limiting.

The generator 410 generates information for displaying, at least on the first user terminal 100, a video displaying at least the character object of the first user in the virtual space. The video here may be a video before or after distribution as displayed on the avatar setting screen D10 (FIG. 6) described above, or may be a video during distribution as displayed on the avatar distribution screen D30 (FIG. 8).

In the former state in which the video is not being distributed, the video described above is displayed only on the first user terminal 100.

In addition, in the latter state in which the video is being distributed, the video described above is displayed not only on the first user terminal 100 but also on the second user terminal 200 of the second user viewing the video.

The information for displaying the above-described video on each user terminal includes motion information indicating movement of the character object, audio information of the first user, gift object information corresponding to a gift sent from the second user, and the like. This information is assumed to be received from the first user terminal 100 and/or the second user terminal 200 by the below-described receiver 420.

As an example, the information sent from the first user terminal 100 includes information for displaying and operating a character object such as motion data and audio data of the first user, display requests for various screens, other operation information, and the like.

As an example, the information sent from the second user terminal 200 includes a display request for an object including a gift, a comment, or the like, and other operation information, and the like.

The receiver 420 receives a lottery request for an item from the first user terminal 100.

As an example, the receiver 420 receives a selection by the first user of the gacha button T23 on the top screen T10 (FIG. 5) or the gacha button D12 displayed on the avatar setting screen D10 (FIG. 6) or the avatar distribution screen D30 (FIG. 8).

When the receiver 420 receives a selection of the gacha button D12 or the like, the one or more computer processors included in the information processing system 3000 of this disclosure deploys, for example, a lottery screen for obtaining avatar parts. Details of the lottery screen are described hereafter.

Similarly, the lottery screen may be deployed by the first user selecting the display field T13 in which a notification about the gacha of the top screen T10 is displayed.

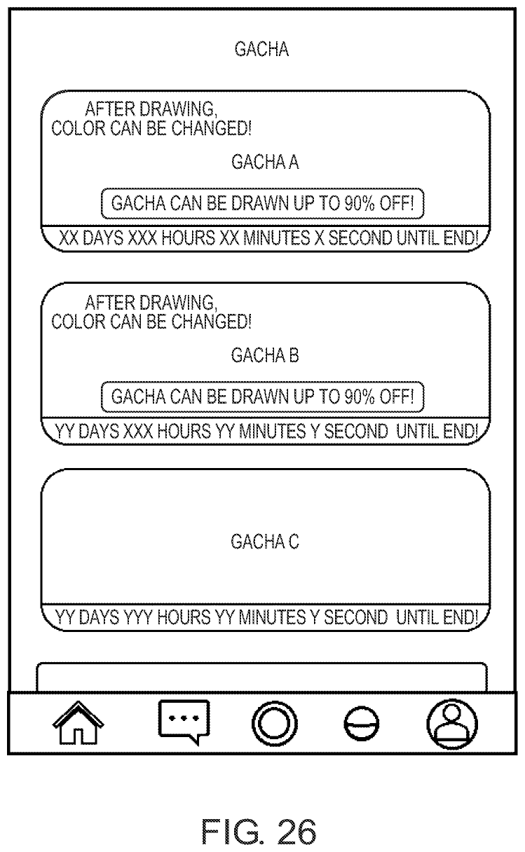

Further, when the first user selects the gacha button D12 or the like, a theme selection screen in which a plurality of gacha themes (gacha A, gacha B, gacha C and the like) is selectably displayed can be displayed on the screen of the first user terminal 100, as shown in FIG. 26.

Each gacha is associated with an item group containing a plurality of items associated with a respective gacha theme.

In addition, each of the gacha themes selectably displayed can display the period until the end, discount information, and below-described information regarding changes.

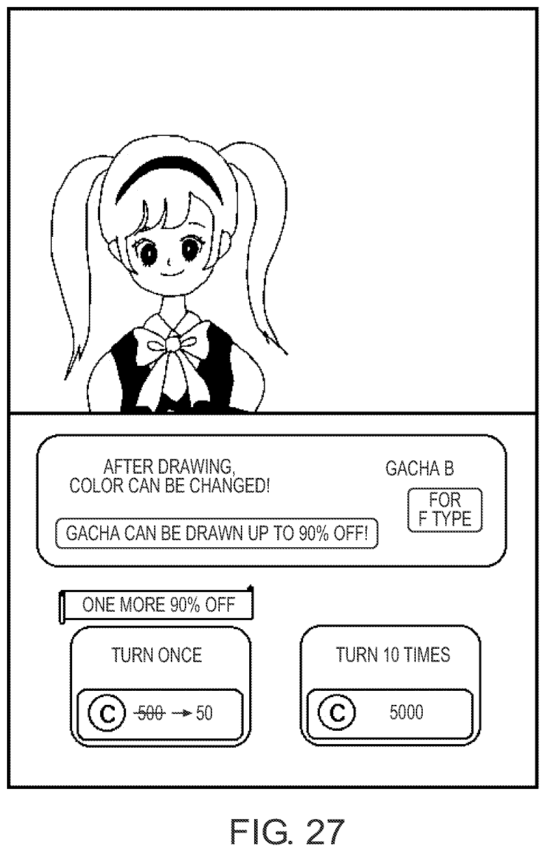

Then, when one gacha theme is selected by the first user, as shown in FIG. 27, a frequency selection screen can be displayed on which the number of times the lottery is performed and the price are selectably displayed.

As an example, for the number of times the lottery will be performed, options of 1 or 10 times are presented. In this specification, a lottery that is performed once with a single lottery request is called a “single lottery (single gacha)”, and a lottery that is performed multiple times (N times) with a single lottery request is called a “consecutive lottery (consecutive gacha)” or “N-consecutive lottery (N-consecutive gacha)”.

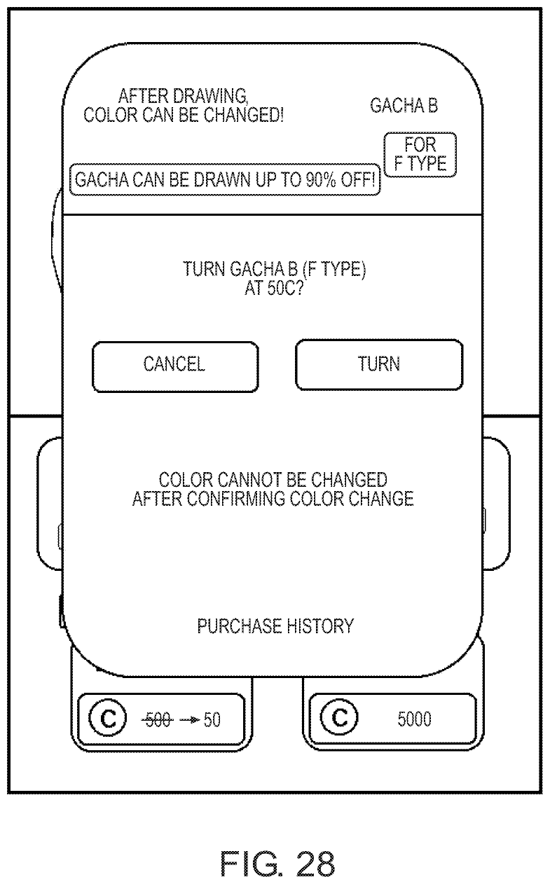

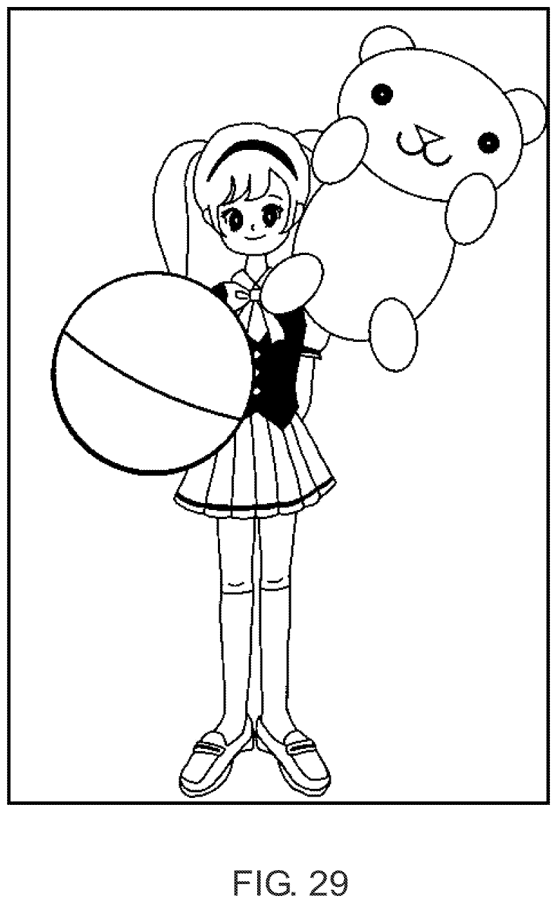

Then, when the first user designates the number of times the lottery is to be performed, the confirmation screen shown in FIG. 28 can be deployed, and the next process can be executed by the processor 430 after a final confirmation by the first user.

The item lottery request from the first user terminal 100 received by the receiver 420 can be sent by a final operation of the first user required by the time the above-described lottery process is performed.

In addition, the above-described lottery request can be made by consuming coins purchased by the first user or gacha tickets given as a login bonus or the like. Alternatively, the above-described lottery request may be made a predetermined number of times free of charge.

Then, in response to receipt of the lottery request by the receiver 420, the processor 430 executes a lottery process to determine at least one item by lottery from an item group including a plurality of items.

In the above-described lottery process, at least one item will be decided by lottery, based on a predetermined probability, the number of times selected by the first user, from the item group associated with the gacha theme selected by the first user.

As an example, when the receiver 420 receives a lottery request for a single gacha, the processor 430 determines one item by lottery.

Similarly, when the receiver 420 receives a lottery request for ten consecutive gachas, the processor 430 determines ten items by lottery.

After the receiver 420 receives a lottery request, until the result screen showing the result of the lottery process is displayed, a predetermined staging screen such as shown in FIG. 29 (as an example, a screen showing a bear appearing with a capsule and in which an item appears from inside as the capsule opens) can be displayed.

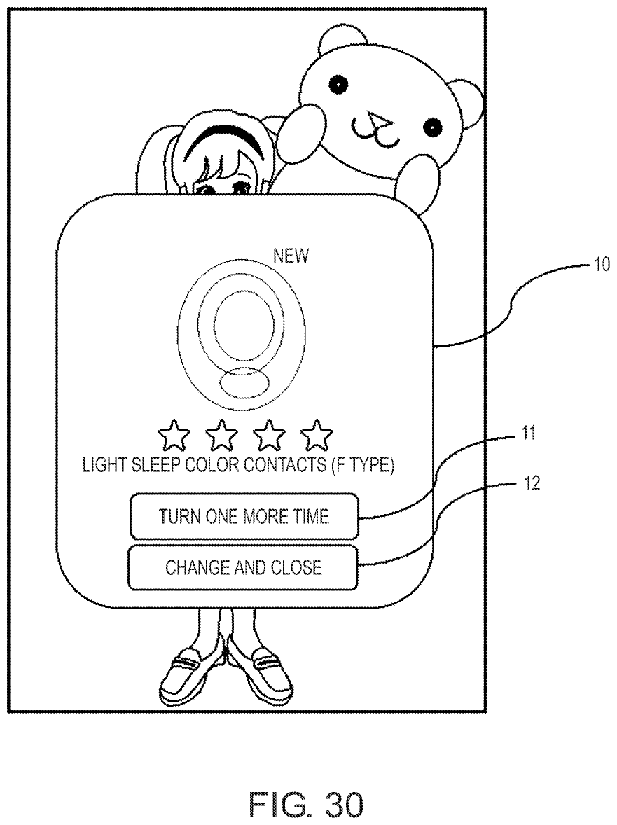

FIG. 30 is an example of a lottery result screen 10 showing a lottery result of a single lottery. On the lottery result screen 10, the image of one item determined by lottery, the name of the item, the gender type, the rarity level (indicated by the number of stars), a “new” mark indicating that the item was obtained for the first time, and the like, can be displayed.

In the case of a single lottery, the above-described lottery result screen 10 may become the below-described result screen 30 in accordance with the result of a determination by the below-described change determination portion 440.

At this time, a re-lottery button 11 and an end button 12 are selectably displayed on the lottery result screen 10, as shown in FIG. 30. When the re-lottery button 11 is selected, the next lottery process is executed, and when the end button 12 is selected, the item is attached to the character object and the lottery process is terminated.

Further, when the end button 12 is selected, the item may be stored as a possessed object in association with the user rather than being attached to the character object and displayed.

The next lottery process performed by selecting the re-lottery button 11 is handled not as a consecutive lottery but as if a single lottery were performed multiple times.

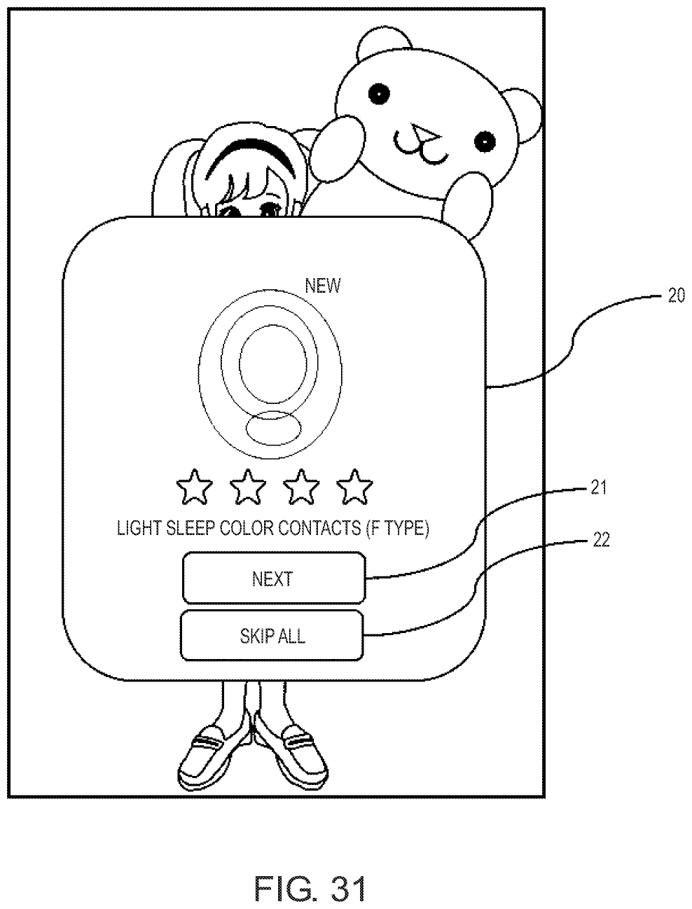

FIG. 31 is an example of a lottery result screen 20 showing lottery results of consecutive lotteries. As in the case of the above-described single lottery, the image of one item determined by lottery, the name of the item, the gender type, the rarity level (indicated by the number of stars), a “new” mark indicating that the item was obtained for the first time, and the like, can be displayed on the lottery result screen 20.

In the case of consecutive lotteries, the lottery result screen 20 can be displayed each time a lottery is performed (10 times for 10 consecutive lotteries).

At this time, a progress button 21 and a skip button 22 as shown in FIG. 31 are selectably displayed on each lottery result screen 20. When the progress button 21 is selected, the next lottery process is performed. When the skip button 22 is selected, the lottery result screen 20 is not displayed from the next lottery process, and the process proceeds to the below-described final result screen.

In FIG. 30 and FIG. 31, the lottery result screens 10 and 20 are displayed as modal screens superimposed on a video.

The change determination portion 440 determines whether the first item determined by the lottery process executed by the processor 430 can be changed to a second item related to the first item.

The second item is not particularly limited as long as it is related to the first item, but examples include items that have a different color and/or different texture.

Details of the determination method will be described later, but for example, if the first user has not yet obtained an item of a different color from the determined item, the determination can be that it is possible to change to an item of a different color.

Such a determination by the change determination portion 440 can be made, for example, before the lottery result screen 20 shown in FIG. 31 is displayed. In this case, it is also possible to display the result of the determination on the lottery result screen 20.

Alternatively, the determination by the change determination portion 440 may be performed after the lottery result screen 20 is displayed and before the below-described final result screen is displayed.

Then, the screen generator 450 generates information for displaying in the video a result screen including an image of the first item determined by the change determination portion 440 to be changeable to the second item, being a result screen showing the result of the lottery process executed by the processor 430. This result screen corresponds to the final result screen described above.

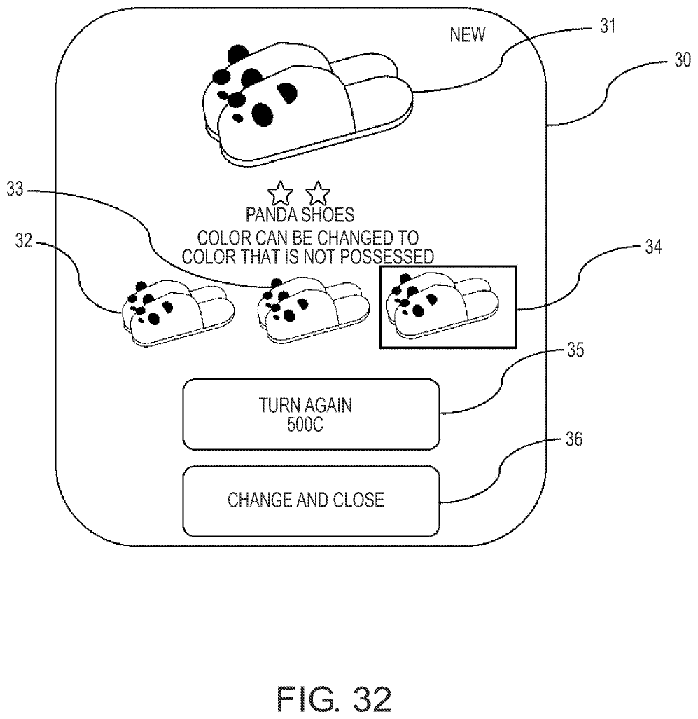

FIG. 32 is an example of a result screen for a single lottery. In the case of a single lottery, only one item is determined, so the result screen 30 including the image of the item is displayed in the video.

When the change determination portion 440 determines that the first item cannot be changed to the second item, a lottery result screen 10 such as is shown in FIG. 30 can be displayed. When the change determination portion 440 determines that the first item can be changed to the second item, a result screen 30 such as is shown in FIG. 32 can be displayed.

In addition, in the case of a single lottery, the result screen 30 shown in FIG. 32 can be a below-described change screen. That is, when the change determination portion 440 determines that a change is possible, the screen generator 450 can generate information for displaying in the video a screen that selectably displays an image of the second item that has been determined to be substitutable (i.e., the second item that has been determined to be an item to which the first item can be changed; the second item with which the first item is replaceable; the second item capable of being introduced as a substitute for the first item) by the change determination portion, being a screen for changing the first item to the second item.

For example, on the result screen 30 shown in FIG. 32, the image 31 of the first item (panda shoes (light blue)) determined by lottery is displayed large in the upper part of a frame, and images of second items (panda shoes (purple), panda shoes (black)) related to the first item and an image (thumbnail image) of the first item (panda shoes (light blue)) are selectably displayed in the lower part of the frame. These first and second items are items that the first user does not yet have (unassociated).

In FIG. 32, the images selectably displayed in the lower part of the frame are, from the left, an image 32 of panda shoes (purple), an image 33 of panda shoes (black), and an image 34 of panda shoes (light blue).

In the example shown in FIG. 32, the image 34 of the first item (panda shoes (light blue)) determined by lottery is initially selected, but the selection can be changed by an operation by the first user.

A re-lottery button 35 and an end button 36 are selectably displayed on the result screen 30. When the re-lottery button 35 is selected, the next lottery process is executed, and when the end button 36 is selected, the item is attached to the character object and the lottery process ends.

The next lottery process executed by selecting the re-lottery button 35 is handled not as a consecutive lottery but as a single lottery performed multiple times.

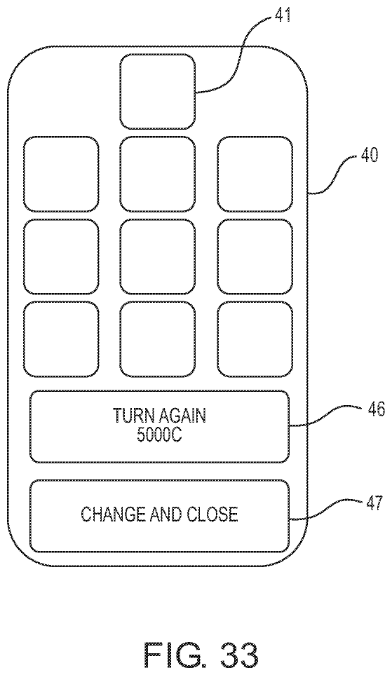

FIG. 33 shows an example of a result screen for consecutive lotteries. In the case of consecutive lotteries, since a plurality of items is determined, a result screen 40 including images of the plurality of items is displayed in the video. On the result screen 40, frames 41 that display the images of the items determined by the consecutive lotteries are displayed, corresponding to the number of lotteries.

Further, on the result screen 40, a re-lottery button 46 and an end button 47 can be displayed.

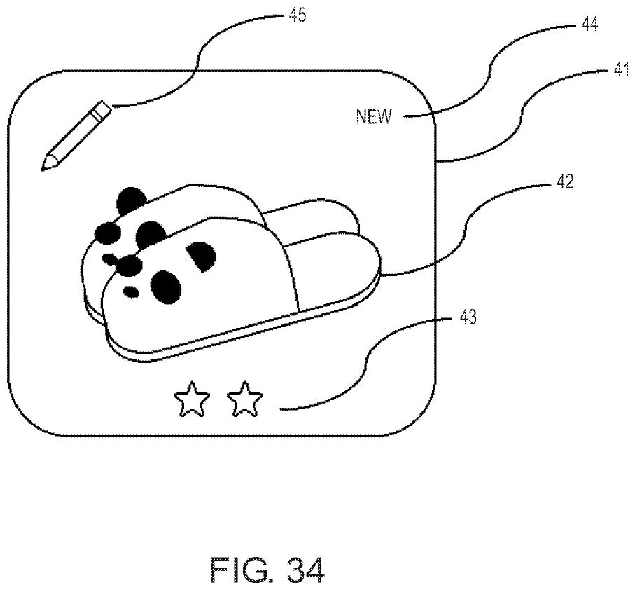

In FIG. 33, a detailed illustration of the inside of the frame 41 in which the image of each item is displayed is omitted, but as an example, FIG. 34 shows a display example within one frame 41.

As shown in FIG. 34, an edit icon 45 can be displayed in the frame 41 in addition to an image 42 of one item determined by lottery, a rarity level 43, a “new” mark 44, and the like. Such an edit icon 45 is displayed only for items determined by the change determination portion 440 to be changeable.

The image 42 of the first item with the edit icon 45 displayed can be selectably displayed. In addition, the entire frame 41 displaying the first item image 42 may be configured to be selectable.

Then, in response to selection by the first user of the first item image 42 selectably displayed, the screen generator 450 can generate information for displaying, in the video, a change screen that selectably displays an image of the second item determined to be substitutable by the change determination portion 440, being a change screen for changing the first item to the second item. Details are described below.

In addition, an edit icon can be displayed on the lottery result screen 10 shown in FIG. 30, and an image of the first item with the edit icon displayed can be selectably displayed. Furthermore, the entire lottery result screen 10 displaying the first item image may be configured to be selectable.

In addition, an edit icon can be displayed on the lottery result screen 20 shown in FIG. 31, and an image of the first item with the edit icon displayed can be selectably displayed. Furthermore, the entire lottery result screen 20 displaying the first item image may be configured to be selectable.

Then, in response to selection by the first user of the image of the first item selectably displayed, the screen generator 450 can generate information for displaying in the video a change screen in which an image of the second item determined to be substitutable by the change determination portion 440 is selectably displayed, being a change screen for changing the first item to the second item. Details are described below.

The above-described configuration can provide a technical improvement that solves or alleviates at least part of the problem of the conventional technology described above. Specifically, with the above configuration, it is possible to expand the means of obtaining items. For example, it is possible to change a first item determined by lottery to a second item related to the first item.

This is more efficient and more advantageous for the user than continuing to perform the gacha to obtain the desired second item.

In addition, preparing a plurality of items that are partly modified from a single item can reduce the costs of creating multiple items compared to creating multiple items from scratch.

Also, in the first user terminal 100, which is assumed to be a smartphone or the like, it may be difficult to display a large amount of information due to the display size. However, by adding an edit icon to the image of the first item displayed on the result screen in the case of consecutive lotteries, as in the above configuration, the user can easily grasp a first item that can be changed to a second item, even while a list of lottery results is being displayed.

Here, the second item can be an item that differs from the first item only in color and/or texture, as described above.

In addition, the part of the second item that differs from the first item is not limited to color and texture, but may be a part of the shape, an attribute that is invisible to the naked eye, or the like.

In addition, the item can be a part that makes up the character object.

The parts that make up the character object are the avatar parts described above, and include the eyes, nose, mouth, hair, accessories, clothes, background, and the like, of the character object.

As another example, the item can be an item other than the parts that make up the character object. For example, this includes furniture, figurines, pets, and the like, that can be placed in the virtual space.

If the second item is not yet associated with the first user, and if the second item is not an item determined by the lottery process executed by the processor 430, the above-described change determination portion 440 can determine that the first item can be changed to the second item.

When the lottery is a single lottery, “the second item not being already associated with the first user” and “the second item not being an item determined by the lottery process executed by the processor 430” have the same meaning.

When the lottery is consecutive lotteries, “the second item not being an item determined by the lottery process executed by the processor 430” has the meaning that the second item is not another item determined in the series of processes of the consecutive lotteries. That is, other items determined in the series of processes of the consecutive lottery are not yet associated with the first user, but can be treated as associated.

For example, the item “panda shoes” has light blue, purple, black, dark blue, peach, yellow, and green as color variations.

Further, suppose that the user already has panda shoes (peach, yellow, and green).

In this case, if panda shoes (light blue) appear in a single lottery, the user can obtain the panda shoes by selecting one color from among the panda shoes (light blue, purple, black, dark blue).

In addition, if panda shoes (light blue, dark blue) appear in consecutive lotteries, one color can be selected from among the panda shoes (light blue, purple, black) on the change screen for the panda shoes (light blue). On the other hand, on the change screen for the panda shoes (dark blue), one color can be selected from among the panda shoes (purple, black, dark blue).

In the above-described example, the configuration is such that the item determined by lottery is also displayed as one of the options for change, but by providing a “change unnecessary” button or the like, the configuration may be such that the item determined by lottery is not displayed as one of the options for change.

As described above, the screen generator 450 can further selectably display on the result screen the image of the first item that has been determined by the change determination portion 440 to be changeable to the second item.

For example, in the case of a single lottery, the image of the first item determined to be changeable to the second item is selectably displayed on the lottery result screen 10 shown in FIG. 30.

In addition, in the case of a consecutive lottery, the frames 41 displayed on the result screen 40 shown in FIG. 33 and including the images of the first items determined to be changeable to the second items can be selected.

Then, the screen generator 450 generates information for displaying the change screen in the video in response to the first user selecting the image of a first item that is selectably displayed.

The change screen is a screen for changing the first item to the second item, and can selectably display the image of the second item determined to be substitutable by the change determination portion 440.

For example, in the case of a single lottery, the screen shown in FIG. 32 corresponds to the change screen. In FIG. 32, the images 32 and 33 of the second items determined to be substitutable by the change determination portion 440 are selectably displayed.

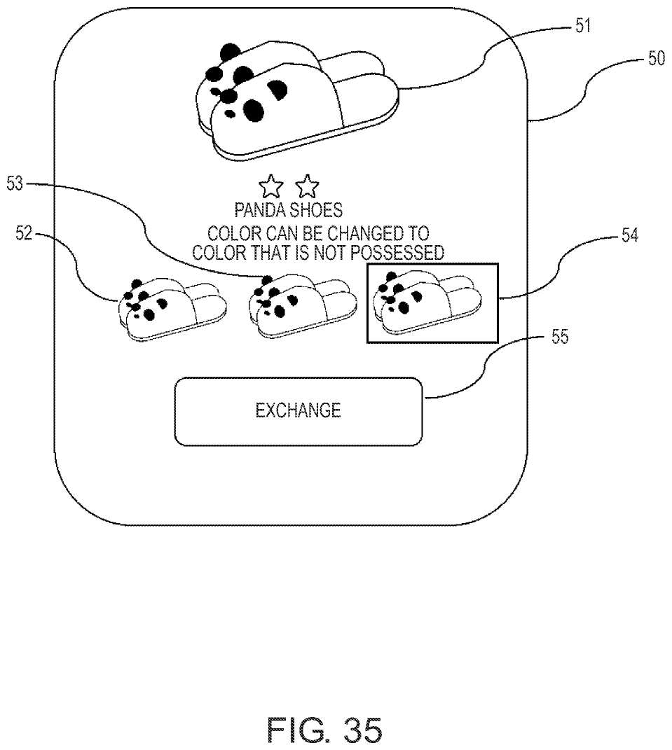

In addition, FIG. 35 shows a change screen for consecutive lotteries. On the change screen 50 shown in FIG. 35, an image 51 of the first item (panda shoes (light blue)) determined by lottery is displayed large in the upper part of the frame, and an image of second items related to the first item (panda shoes (purple), panda shoes (black)) and an image of the first item (panda shoes (light blue)) are selectably displayed in the lower part of the frame. The first item and second items are items that the first user does not already have (is not associated with).

In FIG. 35, the images selectably displayed in the lower part of the frame are, from the left, an image 52 of panda shoes (purple), an image 53 of panda shoes (black), and an image 54 of panda shoes (light blue).

In addition, in FIG. 35, an example is shown in which an image of the first item (panda shoes (light blue)) is selectably displayed in the lower part of the frame, but it is also acceptable for the image of this first item not to be displayed.

In the example shown in FIG. 35, the image 54 of the first item (panda shoes (light blue)) determined by lottery is initially selected, but the selection can be changed by an operation by the first user.

The change screen 50 displays an exchange button 55 that can be selected, and when the exchange button 55 is selected, the change process is terminated or the screen transitions to a confirmation screen described below.

The screen generator 450 can further generate information for displaying in the video a confirmation screen for associating a second item with the first user, in response to the second item selectably displayed on the change screen 30 or 50 being selected by the first user.

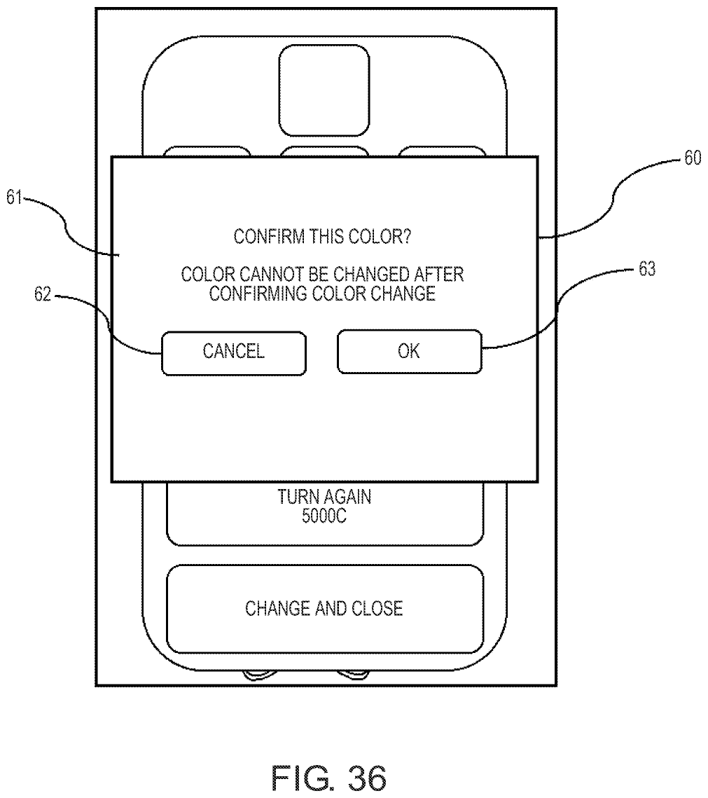

FIG. 36 shows an example of a confirmation screen 60.

On the confirmation screen 60, a confirmation display 61, as well as a cancel button 62 and an OK button 63, can be selectably displayed.

In the above-described example, the confirmation screen 60 is displayed in response to the selection of the image of the second item by the first user, but in the case of a single lottery, after the image of the second item is selected, the confirmation screen 60 may be displayed when the end button 36 or the re-lottery button 35 shown in FIG. 32 is selected.

Similarly, in the above-described example, the confirmation screen 60 is displayed in response to the selection of the image of the second item by the first user, but in the case of consecutive lotteries, after the image is selected, the confirmation screen may be displayed when the end button 47 or the re-lottery button 46 shown in FIG. 33 is selected. In addition, the confirmation screen 60 may be displayed when the exchange button 55 shown in FIG. 35 is selected.

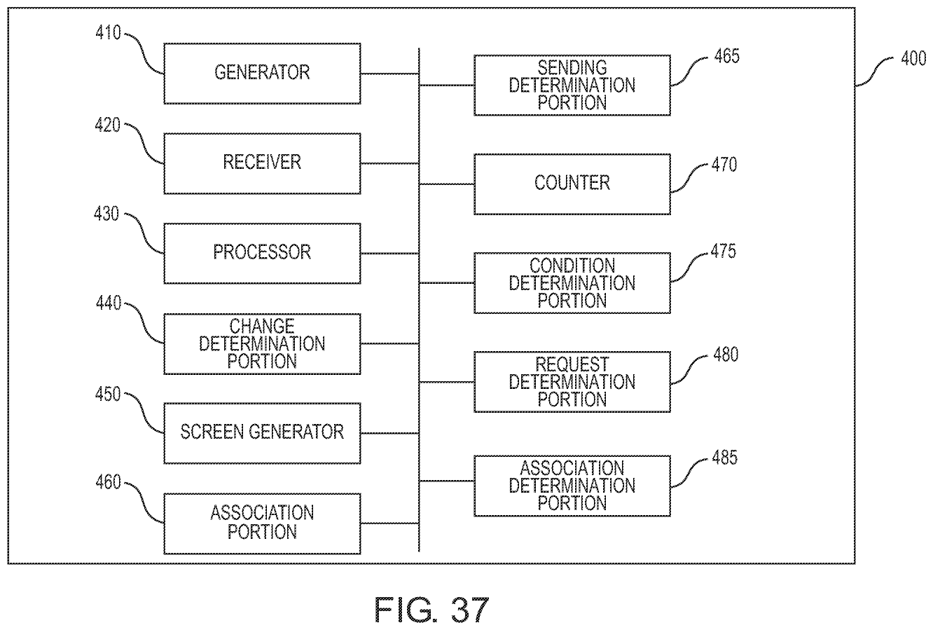

Furthermore, the one or more computer processors can further comprise an association portion 460, as shown in FIG. 37.

The association portion 460 stores the second item in association with the first user in response to the receiver 420 receiving the first user's confirmation operation via the confirmation screen 60.

The confirmation operation can be a selection operation of the OK button 63 shown in FIG. 36. When the cancel button 62 is selected, it is possible to return to the result screens 30 and 40 shown in FIG. 32 and FIG. 33 and do another change.

In the above example, the confirmation screen 60 is displayed in response to the selection of the image of the second item by the first user, but the display timing of the confirmation screen 60 is not limited to such timing.

For example, it is possible to have a configuration in which before or at the same time that the lottery is performed, a screen corresponding to the confirmation screen 60 is displayed to receive a confirmation operation, and it is also possible to have a configuration in which a confirmation operation is unnecessary.

In such a case, the association portion 460 can store the second item in association with the first user in response to the first user's selection of the image of the second item displayed on the change screen.

Before receiving the first user's confirmation operation via the confirmation screen 60, the receiver 420 can receive a reset request that can return the post-change item to the pre-change item.

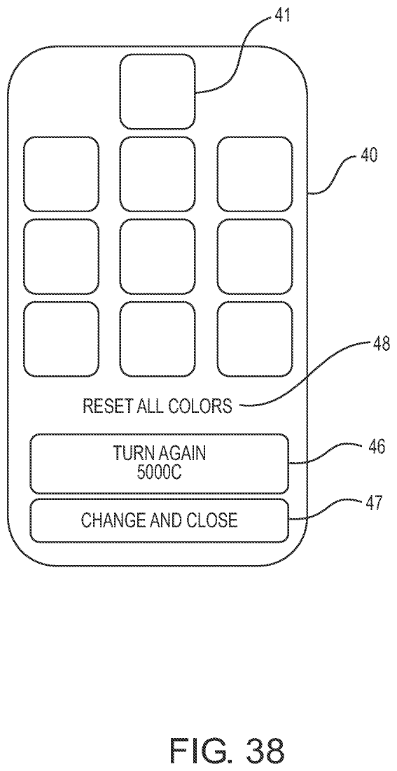

FIG. 38 shows an example of a result screen showing a reset button. As an example, a reset request can be sent by selecting a reset button 48 shown in the result screen 40 shown in FIG. 38. This button may be displayed only if at least one change has been made.

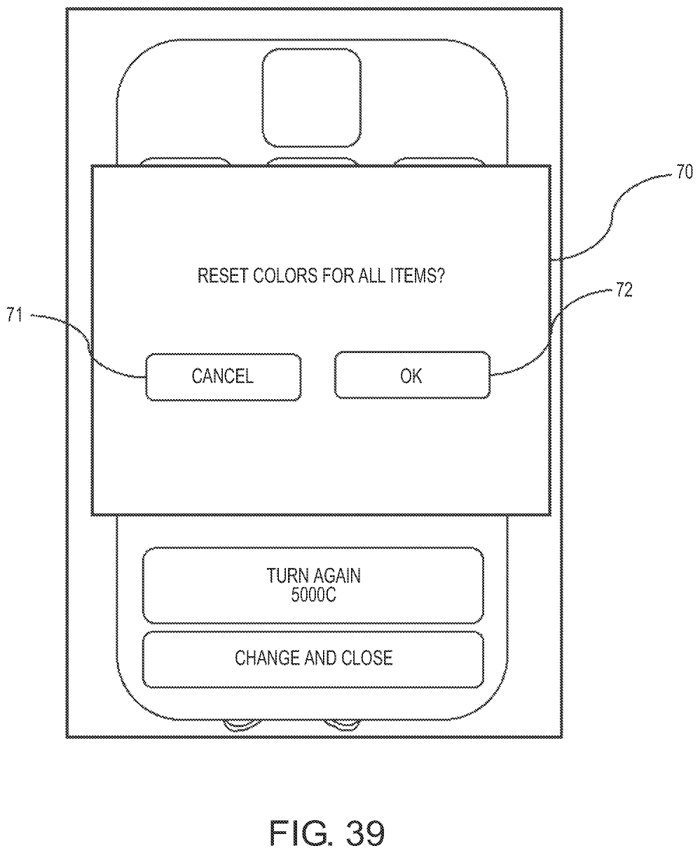

When the reset button 48 is selected in FIG. 38, a reset request is sent, the changes are reset by selecting the OK button 72 on the confirmation screen 70 shown in FIG. 39, and the display returns to the display of the result screen 40 shown in FIG. 33.

By selecting the edit icon 45 without selecting the reset button 48, it is possible to re-change the items one by one, but it may not be possible to return to the first item (initial color). For example, if the initial color (light blue) is not a “new” item, light blue and other colors will be selectably displayed at first, but once the change is made from light blue to another color, the user will be treated as having the light blue item, so even if the attempt is made to change again, the light blue item will not be displayed.

In such a case, by making the above-described reset request, it is possible to collectively return the changed items to the initial items.

The screen generator 450 can further change the image of the first item displayed on the result screen to the image of the second item in response to the first user selecting the image of the second item selectably displayed on the change screen.

For example, when the image 54 of the second item is selected on the change screen 50 shown in FIG. 35, when returning to FIG. 34, the image 42 of the first item shown in FIG. 34 is changed to the image 54 of the second item.

The screen generator 450 can attach a predetermined icon to the image of the first item displayed on the result screen and determined by the change determination portion 440 to be changeable to the second item.

The predetermined icon corresponds to the edit icon 45 shown in FIG. 34.

When the change determination portion 440 determines that there is a plurality of second items to which the first item can be changed, the screen generator 450 can determine the display order and/or display mode of the images of the second items selectably displayed on the change screen, based on user information and/or event information associated with the second items. As an example, the user information associated with the second items can be the number of users associated with the second items.

For example, in the examples shown in FIG. 32 and FIG. 35, images of the second items can be displayed in descending order of the number of users having the second items.

Alternatively, the image of the second item that has the largest number of users who have the second item may have a badge indicating such attached thereto.

Such a configuration would allow the first user to know which items are popular with other users, which could aid the first user's color selection.

At this time, the user information associated with the second item can include relationship information with the first user.

As an example, the relationship information is information indicating relationships such as follow/follower relationships, host/guest relationships, distributing user/viewing user relationships, and the like.

For example, in the examples shown in FIG. 32 and FIG. 35, the images of the second items possessed by users who have the above-mentioned relationships with the first user can have a patch attached thereto indicating such, or the images of the second items can be displayed in descending order of number of users from the left.

The above-described examples are not limiting, and it is also possible to display the images of the second items from the left in order of ID numbers of the items.

The generator 410 can further generate information for displaying a video on the second user terminal 200 of a second user.

At this time, it is assumed that the first user is a distributing user, and that the first user terminal 100 is the information processing device of the distributing user.

Similarly, it is assumed that the second user is a viewing user, and that the second user terminal 200 is the information processing device of the viewing user.

At this time, the one or more computer processors can further comprise a sending determination portion 465 as shown in FIG. 37.

The sending determination portion 465 determines whether information for displaying the video has been sent to the second user terminal 200 of the second user.

In other words, the sending determination portion 465 can determine whether or not the video is being distributed.

Then, as a result of the determination by the sending determination portion 465, the change determination portion 440 can vary the number and/or types of second items determined to be substitutable depending on whether it has been determined that the information for displaying the video has been sent to the second user terminal 200, or whether it has not been determined that the information for displaying the video has been sent to the second user terminal 200.

As an example, it is possible to set color variations and types that are changeable only when a lottery is performed during video distribution.

With such a configuration, it is possible to improve the motivation to perform a lottery during video distribution.

Furthermore, by performing a lottery during video distribution, the lottery function will be known to viewing/participating users through the distribution, and it will be possible to activate item acquisition for all users.

The one or more computer processors can further comprise a counter 470, as shown in FIG. 37.

The counter 470 counts the number of comments and/or object display requests received by the receiver 420 from the second user terminal 200.

At this time, the change determination portion 440 can vary the number and/or types of second items determined to be substitutable according to the number counted by the counter 470. As an example, it is possible to set color variations and types that are changeable only when a lottery is performed while the video is exciting.

The above-described objects include not only gifts but also rating posts such as likes.

With such a configuration, it is possible to further improve the motivation to perform a lottery during video distribution.

The receiver 420 can receive a change request that can change a first item that is the same as an item already associated with the first user into points, prior to receiving a confirmation action by the first user via the confirmation screen 60.

Such points are called avatar points, and are points consumed to send gacha tickets as a viewing user to another distributing user.

With such a configuration, even if an item of the same type and color as an item in hand is drawn, it is possible to choose to convert such to avatar points without changing to another color, so it is possible to effectively use items having no value.

If the application ends without the receiver 420 receiving a confirmation operation of the first user, the screen generator 450 can generate information for displaying in the video any one of the result screen, the change screen, and the confirmation screen when the receiver 420 has subsequently received a lottery request for an item from the first user terminal 100 or has received a display request for an item that is stored in association with the first user.

The above configuration specifies the process at the time of abnormal termination due to application failure, task kill, or the like. Which of the result screen, the change screen, and the confirmation screen is displayed can be determined in accordance with the timing at which the application ends.

With this configuration, if an item is lost due to an unexpected crash or the like before being associated with the first user, it is possible to display the above-described screen at the time when transitioning to the closet screen, or when transitioning to an arbitrary gacha screen, or when the gacha button is selected during live distribution.

This functions as a block function that does not allowed a new gacha to be pulled when there are items in an incomplete state before being associated after being determined by the lottery process. As a result, it becomes possible to reliably associate an item with the user, thereby preventing a situation in which an item that the user should have won in the lottery cannot be found among the items held by the user.

In addition, a function may be provided that allows the user to suspend the above-described change/confirmation by a means other than the above-described abnormal termination. With such a configuration, until the first user performs the next gacha, it is possible for the color to be left unconfirmed.

The receiver 420 can also receive comments and/or object display requests for the video from the second user terminal 200.

Furthermore, the receiver 420 can further receive, from the first user terminal 100, an operation for switching whether or not to display a comment and/or object in a video that is displaying a result screen.

The above-described configuration can be applied not only to the result screen but also to any screen, such as the lottery result screen, the change screen, the confirmation screen, or the like.

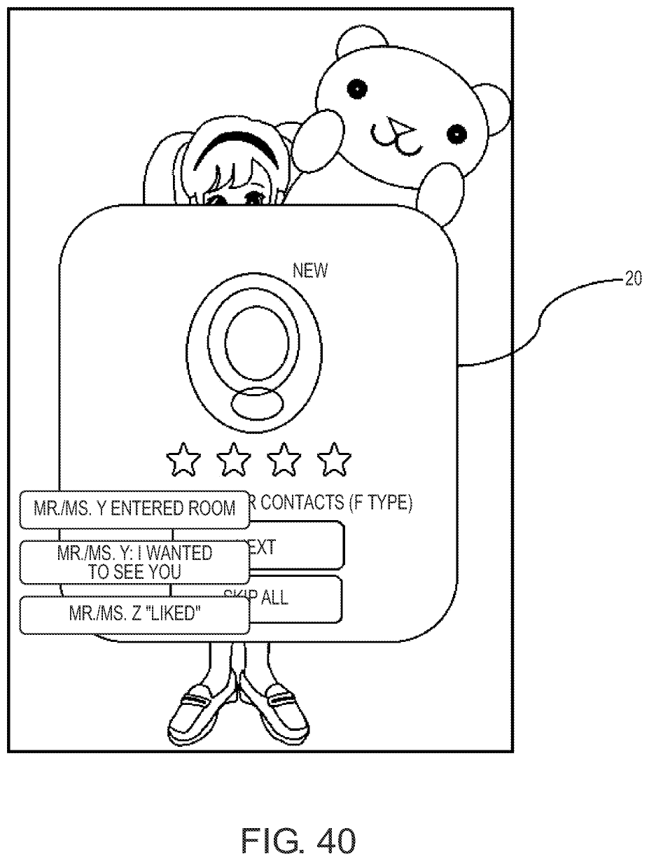

For example, FIG. 40 shows an example in which comments are displayed superimposed on the lottery result screen 20. Conventionally, when distributing users have requested that they want to decide on the color while listening to what is hoped for by and popular with viewing users, but comments and objects are displayed during the lottery process, during the change process and when displaying lottery results, there is a risk that the screen will be hidden and difficult to see, and conventionally, the display of comments and/or objects is generally stopped at such times. However, such conventional configurations may detract from the live experience. Therefore, with the above-described configuration of this disclosure, it is possible to switch between the presence and absence of such a display, so that it is possible to reflect the desires of the first user regarding the display of the screen.

The switching operation can be an operation of selecting a region other than the result screen of the video.

For example, the first user can perform the switching operation by tapping a region at which a region (for example, a background object) other than the various screens displayed in the video is displayed.

Furthermore, when a comment and/or an object is displayed by the switching operation received by the receiver 420, the generator 410 can change the display mode of the comment and/or the object so that the comment and/or object is displayed such that the result screen displayed in the video is avoided (i.e., such that the comment and/or object does not overlap the result screen).

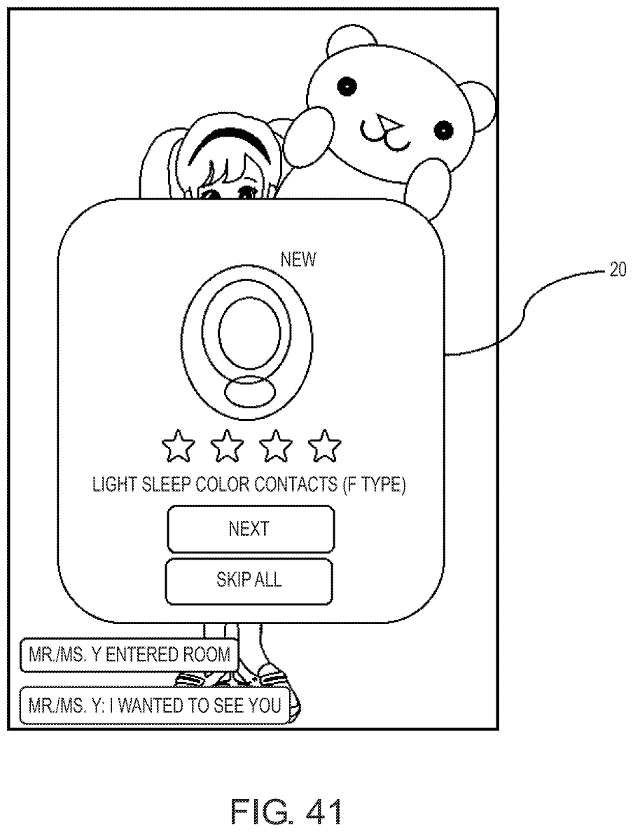

As one example, FIG. 41 is an example in which comments are displayed while avoiding the lottery result screen 20. Although the lottery result screen 20 is shown as an example in FIG. 41, the above-described configuration can be applied to any screen such as the result screen, the change screen, the confirmation screen, or the like.

FIG. 41 shows an example in which comments and/or objects are displayed while avoiding the lottery result screen 20 by reducing the number of lines, but this is not limiting, for a configuration that scrolls horizontally in one line, or the like, may be used. With such a configuration, even when comments and/or objects are displayed, it is possible to reduce the difficulty of viewing the screen.

In addition, even if the screen of the first user terminal 100, which is assumed to be a smartphone or the like, is small, it is possible to confirm lottery results and smoothly execute a color change while viewing the comments.

In addition, with the information processing system of this disclosure, it is possible to employ a configuration in which comments posted while the change screen is displayed are analyzed, and if a comment includes text indicating a color, to highlight a thumbnail of the image of the second item corresponding to that color.

With this configuration, communication between the first user and the second user can be further activated.

In addition, the one or more computer processors can further comprise a request determination portion 480, as shown in FIG. 37.

The request determination portion 480 determines whether or not a lottery request is a lottery request for a specific item group.

At this time, when the request determination portion 480 determines that the lottery request is a lottery request for a specific item group, the change determination portion 440 can determine whether the above-described change is possible.

A specific item group is a color-changeable gacha. As shown in FIG. 26, color-changeable gachas can be accompanied by text and icons to that effect.

When there is a plurality of second items that the change determination portion 440 determines to be substitutable, the receiver 420 can receive a bulk change request capable of collectively changing each of the first items into the corresponding second items, and the bulk change request can include the specification of one color.

Bulk change requests can be sent from the result screen or change screen. For example, a bulk change request button may be displayed on the result screen, the change screen, or the like, and a bulk change request may be sent by selecting the button.

In addition, the type of color or pattern variation may differ for each item. In such cases, the color to be changed by specifying one color is not necessarily limited to the same color. At this time, the color to be changed can be determined in advance by a color code or the like.

For example, if one color (red) is specified in a bulk change request, this may be handled as if an item of the warm color group to which the color belongs (is associated) is specified, or the configuration may be such that a rough color group such as warm color group/cold color group or the like can be specified in the bulk change request.

With the above configuration, even if the screen of the first user terminal 100, which is assumed to be a smartphone or the like, is small, there is no need to repeat multiple changes, and the burden of change operations during consecutive lotteries can be reduced.

The one or more computer processors may further comprise an association determination portion 485, as shown in FIG. 37.

The association determination portion 485 determines whether a specific electronic medium is associated with the first user.

At this time, when the association determination portion 485 determines that a specific electronic medium is associated with the first user, the change determination portion 440 can determine whether the above-described change is possible.

Alternatively, when the change determination portion 440 determines that the change is possible, the association determination portion 485 can determine whether a specific electronic medium is associated with the first user.

As an example, the specific electronic medium may be an electronic medium that is purchasable by the first user and that has associated therewith expiration date information and/or usage count information. The expiration date can be automatically renewed unless the first user gives a cancellation instruction. That is, this specific electronic medium is used for subscription-based services. Types of subscription services include a limited-count type and a limited-time type.

In this disclosure, the specific electronic medium shall be referred to as a “pass” to distinguish from the above-described coins, points, tickets, and the like. As an example, a specific electronic medium can be used as a color pass to change the color of items that appear in gachas.

Also, attribute information can be further associated with the specific electronic medium.

The attribute information is, for example, a theme. A first user can select and purchase a theme when purchasing the electronic medium. In the case of a color pass, the theme is a color taste such as pastel, pink, black, or the like.

For example, if the first user has a color pass associated with pink taste attribute information, only images of second items in pinkish colors are selectably displayed on the change screen.

In addition, although this disclosure has been described assuming that the image of the second item is selectably displayed, the configuration may be such that one color can be selected from a color palette that is presented.

As noted above, a second item may be an item of a different color from a first item.

At this time, the specific electronic medium functions as a color pass for color change. Similarly, a second item can be an item in which the texture of a first item has been UV-scrolled.

UV scrolling is a method of making additions to or subtractions from UV coordinates set in the texture to make the image appear as if scrolling. Examples include glittering stars and flowing text.

At this time, the electronic medium functions as a UV scroll pass for UV scrolling.

In addition, the second item can be an item with the texture of the first item changed.

At this time, the electronic medium functions as a texture pass for texture modification.

In addition, the electronic medium may also function as a rarity pass to increase the rarity of the first item. At this time, the above-described UV scrolling may be applied to the first item as the rarity is increased.

Commonly known methods can be applied as the purchase method of the specific electronic medium, but the configuration may also be such that confirming, purchasing, updating, cancelling, and the like, of the pass is possible from the profile screen of the first user.

As described above, with the information processing system 3000 of this disclosure, it is possible to change the color of an item obtained by a lottery such as a gacha to any color within the color variations. Through this, a gacha item (including color) the user wants can be obtained more easily, and dissatisfaction with and distrust of the lottery can be eliminated, making it possible to improve the gacha consumption rate.

Next, an example of an information processing method according to an embodiment of this disclosure will be described.

The information processing method in an embodiment of this disclosure is the information processing method in the information processing system 3000 shown in FIG. 3. The information processing system 3000 comprises at least the first user terminal 100 and the server device 400.

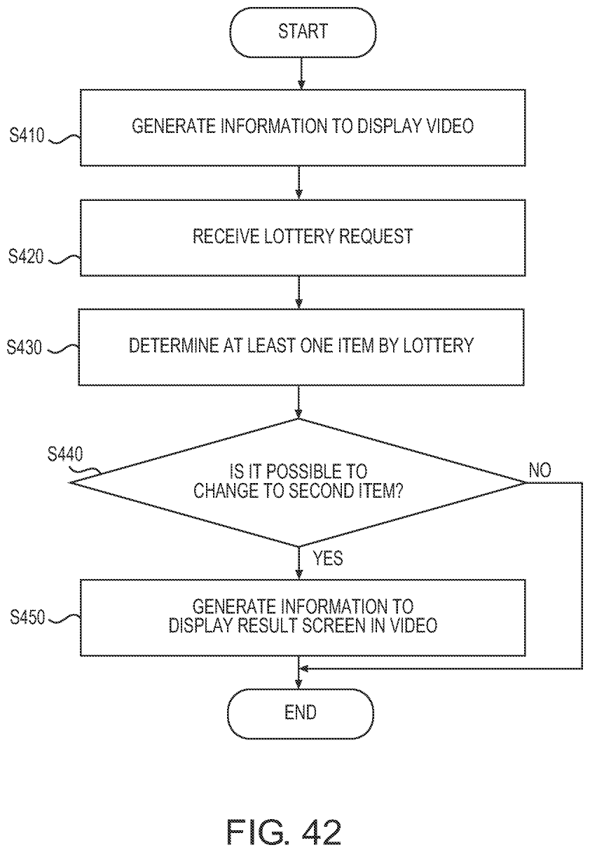

An information processing method according to this disclosure is characterized by causing one or more computer processors included in the information processing system 3000 to execute steps S410 to S450, as shown in FIG. 42 as an example.

In step S410, information is generated for displaying, on at least the first user terminal 100, a video displaying at least a character object of the first user in a virtual space. This step S410 can be executed by the generator 410 described above.

Step S410 may be executed on the server side (the server device 400) or may be executed on the client side (the first user terminal 100).

In step S420, an item lottery request is received from the first user terminal 100. This step S420 can be executed by the receiver 420 described above.

Step S420 may be executed on the server side (the server device 400) or may be executed on the client side (the first user terminal 100).

In step S430, in response to the receipt of the lottery request, a lottery process is executed to determine at least one item by lottery from an item group containing a plurality of items. This step S430 can be executed by the processor 430 described above.

Step S430 may be executed on the server side (the server device 400) or may be executed on the client side (the first user terminal 100).

In step S440, a determination is made as to whether or not the first item determined by the lottery process can be changed to a second item related to the first item. This step S440 can be executed by the change determination portion 440 described above.

Step S440 may be executed on the server side (the server device 400) or may be executed on the client side (the first user terminal 100).

In step S450, information is generated for displaying, in a video, a result screen showing the result of the lottery process, the result screen including an image of the first item determined to be changeable to the second item. This step S450 can be executed by the screen generator 450 described above.

Step S450 may be executed on the server side (the server device 400) or may be executed on the client side (the first user terminal 100).

An image of a first item determined to be unchangeable may be included in the result screen. At this time, the first item determined to be unchangeable and the first item determined to be changeable are displayed so as to be distinguishable. Alternatively, the image of the first item determined to be unchangeable may be displayed separately from the result screen that includes the image of the first item determined to be changeable.

The above-described configuration provides a technical improvement that solves or alleviates at least part of the problem of the conventional technology described above.

Next, a computer program according to an embodiment of this disclosure will be described.

A computer program according to an embodiment of this disclosure is a computer program executed in the information processing system 3000 shown in FIG. 3. The information processing system 3000 comprises at least the first user terminal 100 and the server device 400.

The computer program according to this disclosure is characterized by causing one or more computer processors included in the information processing system 3000 to realize a generation function, a reception function, a processing function, a change determination function, and a screen generation function.

The generation function generates information for displaying, on at least the first user terminal 100, a video displaying at least a character object of a first user in a virtual space.

The reception function receives an item lottery request from the first user terminal 100.

The processing function executes a lottery process for determining at least one item by lottery from among an item group containing a plurality of items in response to receipt of the lottery request.

The change determination function determines whether the first item determined by the lottery process can be changed to a second item related to the first item.

The screen generation function generates information for displaying, in a video, a result screen showing the result of the lottery process, the result screen including an image of the first item determined to be changeable to the second item.

An image of a first item determined to be unchangeable may be included in the result screen. At this time, the first item determined to be unchangeable and the first item determined to be changeable are displayed so as to be distinguishable. Alternatively, the image of the first item determined to be unchangeable may be displayed separately from the result screen that includes the image of the first item determined to be changeable.

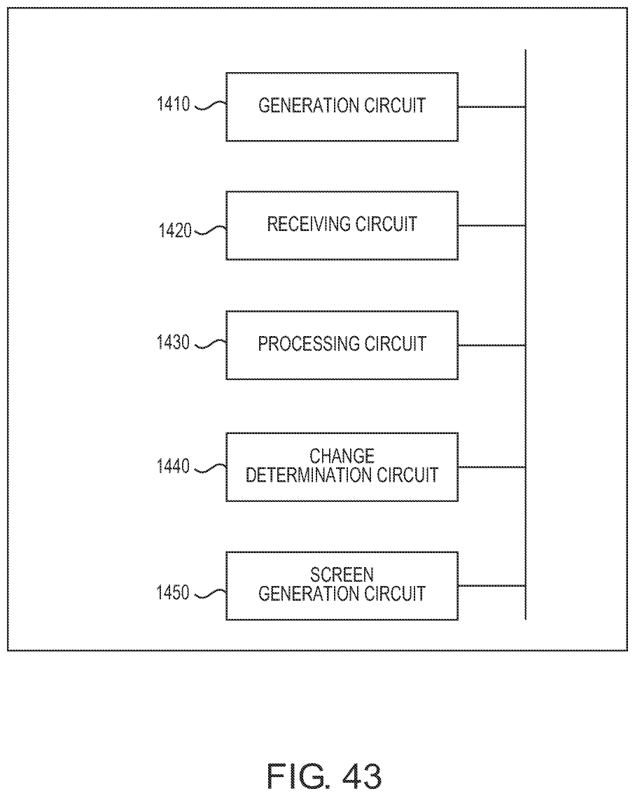

The above-described functions can be implemented by circuits 1410 to 1450 shown in FIG. 43. A generation circuit 1410, a receiving circuit 1420, a processing circuit 1430, a change determination circuit 1440, and a screen generation circuit 1450 are realized by the generator 410, the receiver 420, the processor 430, the change determination portion 440, and the screen generator 450, described above, respectively. Details of each part are as described above.

The above-described configuration provides a technical improvement that solves or alleviates at least part of the problem of the conventional technology described above.

Next, an information processing device according to an embodiment of this disclosure will be described. The information processing device corresponds to the first user terminal 100 in the information processing system 3000 described above.

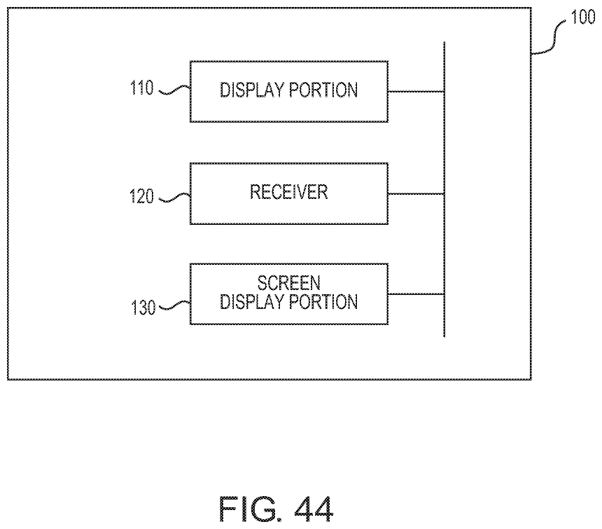

The information processing device includes a display portion 110, a receiver 120 and a screen display portion 130, as shown in FIG. 44.

The display portion 110 displays a video in which at least a character object of a first user is displayed in a virtual space.

The receiver 120 receives an item lottery request.

The screen display portion 130 displays a result screen that shows an image of a first item determined by a lottery process executed in response to the lottery request being received by the receiver 120, the first item having been determined to be changeable to a second item, in a manner differing from an image of an item determined to be unchangeable to the second item. Furthermore, when the lottery process and determination are performed by the information processing device, the information processing device may further include a processor and a change determination portion.

In response to receipt of a lottery request by the receiver 120, the processor executes a lottery process that determines by lottery at least one item from an item group including a plurality of items.

The change determination portion determines whether the first item determined by the lottery process executed by the processor can be changed to a second item related to the first item.

The above-described configuration provides a technical improvement that solves or alleviates at least part of the problem of the conventional technology described above.

Next, an example of an information processing method according to an embodiment of this disclosure will be described. This information processing method is an information processing method executed in the information processing device (first user terminal 100) described above.

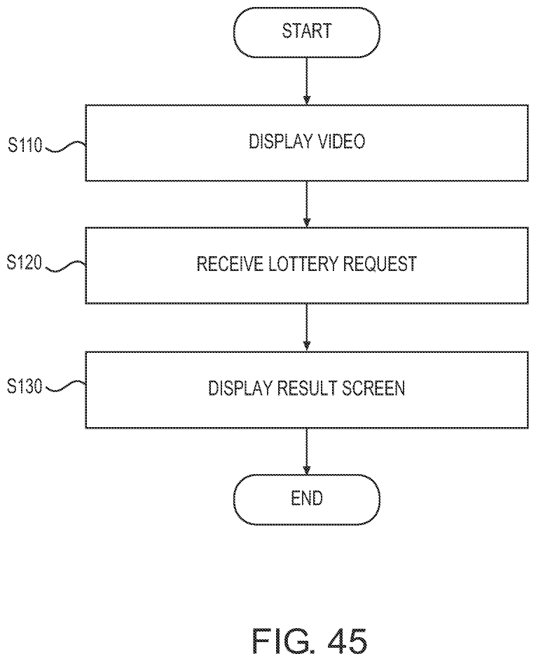

The information processing method according to this disclosure is characterized by causing one or more computer processors included in the information processing device to execute steps S110 to S130, as shown in FIG. 45 as an example.

In step S110, a video displaying at least a character object of a first user in a virtual space is displayed. This step S110 can be executed by the display portion 110 described above.

In step S120, an item lottery request is received. This step S120 can be executed by the receiver 120 described above.

In step S130, an image of a first item determined by a lottery process executed in response to receipt of the lottery request and determined to be changeable to a second item is displayed on a result screen that displays the image in a different manner from the image of an item determined to be unchangeable to the second item. This step S130 can be executed by the screen display portion 130 described above.

Furthermore, when the lottery process and the determination are executed by the above-described information processing device, the one or more computer processors can be caused to further execute a processing step and a change determination step.

In the processing step, a lottery process is executed that determines through lottery at least one item from among an item group including a plurality of items, in response to receipt of the lottery request.

In the change determination step, a determination is made as to whether or not the first item determined by the lottery process can be changed to the second item related to the first item.

The above-described configuration provides a technical improvement that solves or alleviates at least part of the problem of the conventional technology described above.

Finally, a computer program according to an embodiment of this disclosure will be described. This computer program is a computer program executed by the information processing device (the first user terminal 100) described above.

A computer program according to this disclosure is characterized by causing one or more computer processors included in an information processing device to realize a display function, a reception function, and a screen display function.

The display function displays a video that displays at least a character object of a first user in a virtual space.

The reception function receives an item lottery request.

The screen display function displays a result screen in which a first item determined by a lottery process executed in response to receipt of the lottery request, the first item having been determined to be changeable to a second item, is displayed in a manner different from the image of an item determined to be unchangeable to the second item.

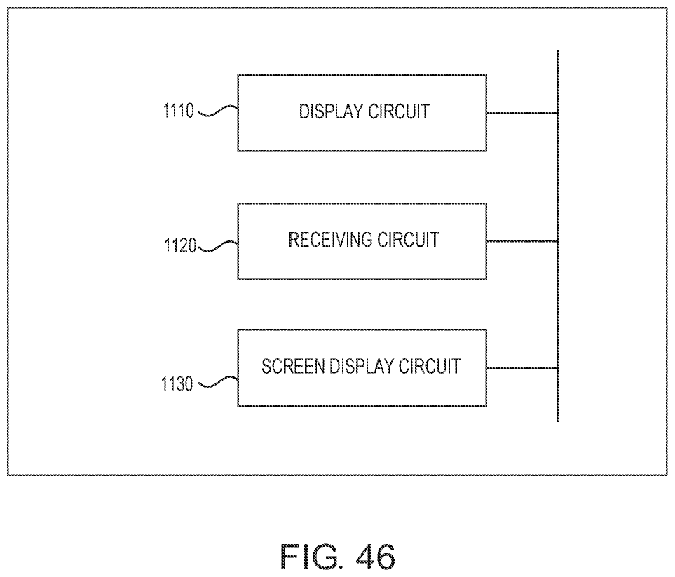

The above functions can be realized by a display circuit 1110, a receiving circuit 1120, and a screen display circuit 1130 shown in FIG. 46. The display circuit 1110, the receiving circuit 120 and the screen display circuit 1130 are realized by the display portion 110, the receiver 120, and the screen display portion 130 described above, respectively. Details of each are as described above.

Furthermore, when the lottery process and the determination are executed by the information processing device, the one or more computer processors can further realize a processing function and a change determination function.

The processing function executes a lottery process for determining at least one item by lottery from among an item group containing a plurality of items, in response to receipt of the lottery request.

The change determination function determines whether the first item determined by the lottery process can be changed to a second item related to the first item.

The above-described configuration provides a technical improvement that solves or alleviates at least part of the problem of the conventional technology described above.

In order to function as the server device or the terminal device according to the above-described embodiments, an information processing device such as a computer or a mobile phone can be suitably used. Such an information processing device can be realized by storing in the memory of the information processing device a program that describes processing details for realizing each function of the server device or the terminal device according to the embodiment, and having the CPU of the information processing device read out and execute the program.

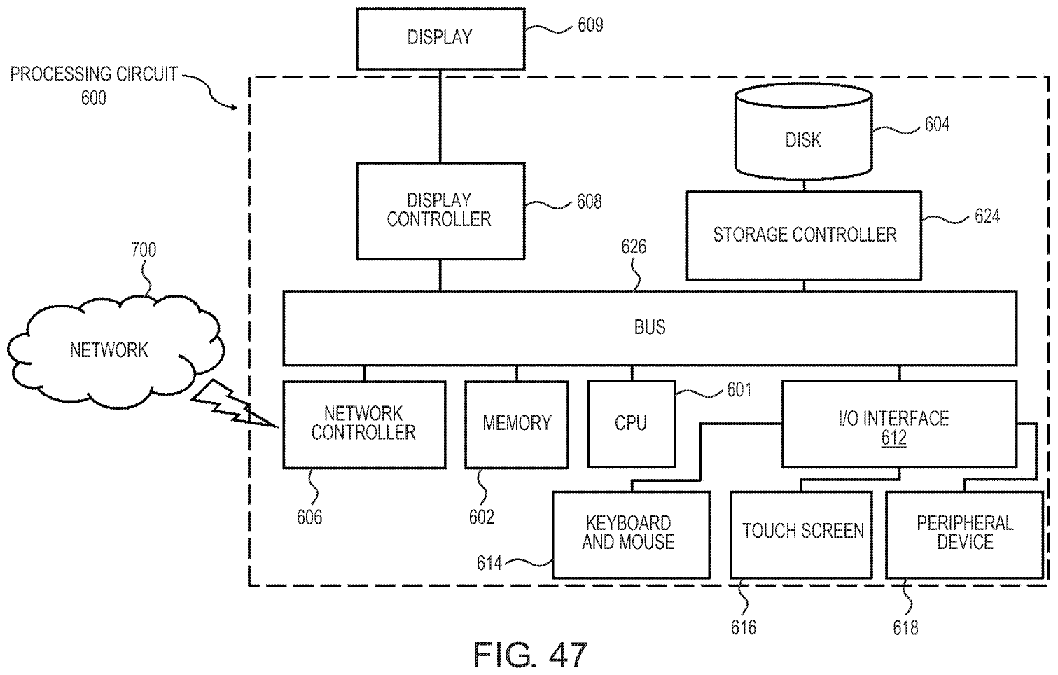

FIG. 47 is a block diagram of processing circuitry for performing computer-based operations in accordance with this disclosure. FIG. 47 shows a processing circuit 600, which corresponds to a CPU of the terminal(s) and device(s) in this disclosure.

The processing circuit 600 can be used to control any computer-based or cloud-based control process, and the flowchart descriptions or blocks can be understood as expressing modules, segments or portions of one or more executable commands for implementing specific logical functions or steps within the process, and alternative implementations are included within the exemplary embodiments of this advancement in which the function may be executed. The order from that shown or discussed includes substantially the same or the reverse order depending on the functionality involved, as will be understood by one skilled in the art. The functionality of the elements disclosed herein can be implemented using processing circuits or circuits including general purpose processors, special purpose processors, integrated circuits, ASICs (“Application Specific Integrated Circuits”), conventional circuits configured or programmed to perform the disclosed functions, and/or combinations thereof. A processor includes circuitry having transistors and other circuits therewithin, or processes such circuitry. The processor may be a processor programmed to execute programs stored in memory. In this disclosure, processing circuits, units, and means are hardware that performs or is programmed to perform the enumerated functions. The hardware can be any hardware disclosed herein or any commonly known hardware that is otherwise programmed or configured to perform the enumerated functions.

In FIG. 47, the processing circuit 600 includes a CPU 601 that executes one or more of the control processes discussed in this disclosure. Process data and instructions may be stored in a memory 602. These processes and instructions may also be stored on a storage medium disk 604, such as a hard drive (HDD) or portable storage medium, or may be stored remotely. Furthermore, the advancement(s) recited in the scope of the claims is not limited by the form of computer-readable media on which the instructions of the process are stored. For example, the instructions may be stored on a CD, DVD, flash memory RAM, ROM, PROM, EPROM, EEPROM, hard disk, or any other non-transitory computer-readable medium in an information processing device with which the processing circuit 600 communicates, such as a server or computer. The processes may also be stored in network-based storage, cloud-based storage, or other mobile-accessible storage and executable by the processing circuit 600.

Further, the claimed advancement may be provided as a utility application, a background daemon, or an operating system component, or as a combination thereof, and can be executed along with the CPU 601 and an operating system such as Microsoft Windows, UNIX, Solaris, LINUX, Apple MAC-OS, Apple IOS and other systems known to those skilled in the art.

The hardware elements for realizing the processing circuit 600 may be realized by various circuit elements. In addition, each function of the above-described embodiment may be realized by a circuit including one or more processing circuits. The processing circuits include a specially programmed processor, such as the processor (CPU) 601 shown in FIG. 47. The processing circuits also include devices such as application specific integrated circuits (ASICs) and conventional circuit components arranged to perform the enumerated functions.

Alternatively, or additionally, the CPU 601 may be implemented on an FPGA, ASIC, or PLD, or using discrete logic circuits, as will be appreciated by those skilled in the art. Also, the CPU 601 may be realized as a plurality of processors operating in parallel and in cooperation to execute the above-described instructions of the processes of this disclosure.

The processing circuit 600 of FIG. 47 also includes a network controller 606 such as an Ethernet PRO network interface card for interfacing with the network 700. As can be appreciated, the network 700 can be a public network such as the Internet, or a private network such as a local area network (LAN) or wide area network (WAN), or any combination thereof, and may also include a public switched telephone network (PSTN) or integrated services digital network (ISDN) sub-networks. The network 700 can also be wired, such as an Ethernet network, a Universal Serial Bus (USB) cable, or the like, or wireless, such as a cellular network including EDGE, 3G and 4G wireless cellular systems. The wireless network can also be Wi-Fi, wireless LAN, Bluetooth, or any other form of wireless communication known. Additionally, the network controller 606 may comply with other direct communication standards such as Bluetooth, Near Field Communication (NFC), infrared or others.

The processing circuit 600 further includes a display controller 608, such as a graphics card or graphics adapter, for interfacing with a display 609, such as a monitor. An I/O interface 612 interfaces with a keyboard and/or a mouse 614 and a touch screen panel 616 on or separate from the display 609. The I/O interface 612 also connects to various peripheral devices 618.

A storage controller 624 connects the storage media disk 604 with a communication bus 626, which may be ISA, EISA, VESA, PCI or similar, and which interconnects all components of the processing circuit 600. A description of the general features and functionality of the display 609, the keyboard and/or mouse 614, the display controller 608, the storage controller 624, the network controller 606, and the I/O interface 612, is omitted here for brevity because these features are commonly known.

The exemplary circuit elements described in the context of this disclosure may be replaced with other elements or may be of different construction than the examples provided herein. Further, circuits configured to perform the functions described in this specification may be implemented in multiple circuit units (e.g., chips), or the features may be combined in circuits on a single chipset.

The functions and features described herein may also be performed by various distributed components of the system. For example, one or more processors may perform these system functions, where the processors are distributed among a plurality of components communicating within a network. Distributed components can include one or more client and server machines that can share processing, as well as various human interfaces and communication devices (e.g., display monitors, smartphones, tablets, or personal digital assistants (PDAs)). The network may be a private network such as LAN or WAN, or a public network such as the Internet. Input to the system is received through direct user input and can be received remotely in real time or as a batch process. Moreover, some implementations may be performed on modules or hardware that are not identical to those described. Accordingly, other implementations are within the scope of what is claimed.

While several embodiments of the disclosure have been described, these embodiments are provided by way of example and are not intended to limit the scope of the disclosure. These novel embodiments can be implemented in various other forms, and various omissions, replacements, and modifications can be made without departing from the spirit of the disclosure. These embodiments and their modifications are included in the scope and gist of the disclosure, and are included in the scope of the claims, and their equivalents.

Further, the methods described in the embodiments can be stored on a recording medium such as a magnetic disk (floppy (registered trademark) disk, hard disk, or the like), optical disc (CD-ROM, DVD, MO, or the like), semiconductor memory (ROM, RAM, flash memory, or the like), or the like, as programs that can be executed by a computer (computer), or can be sent and distributed via a communication medium. The programs stored on the medium include setting programs that configure, in the computer, software means (including not only executable programs but also tables and data structures) executed by the computer. A computer that realizes this device reads a program stored on a recording medium, and depending on the case, constructs software means by a setting program, and executes the above-described processes through operations controlled by the software means. The term “recording medium” as used herein is not limited to those for distribution, and includes storage media such as magnetic disks and semiconductor memory provided inside the computer or equipment connected via a network. A memory may function, for example, as a main memory device, an auxiliary memory device, or cache memory.

### EXPLANATION OF SYMBOLS

100 First user terminal
200 Second user terminal
300 Network
400 Server device
410 Generator
420 Receiver
430 Processor
440 Change determination portion
450 Screen generator

1. An information processing system comprising:
one or more processors programmed to:
generate information for displaying, on at least a first user terminal, a video that displays at least a first character object of a first user in a virtual space,
receive a lottery request for an item from the first user terminal,
execute a lottery process that determines a first item from among an item group including a plurality of items, in response to receiving the lottery request,
determine whether the first item determined by the lottery process is replaceable with a second item related to the first item, and
generate information for displaying in the video a result screen showing a result of the lottery process, the result screen including an image of the first item determined to be replaceable with the second item.

2. The information processing system according to claim 1, wherein
the one or more processors determine that the first item is replaceable with the second item when the second item is not yet associated with the first user, and when the second item is not an item determined by the lottery process.

3. The information processing system according to claim 1, wherein
the one or more processors further generate information for displaying, in the video, a change screen for changing the first item to the second item,
the change screen is displayed in response to the image of the first item being selected on the result screen, and
the change screen displays an image of the second item with which the first item is replaceable.

4. The information processing system according to claim 3, wherein
the one or more processors further
generate information for displaying in the video a confirmation screen for associating the second item with the first user in response to the first user selecting the image of the second item displayed on the change screen, and
store the second item in association with the first user in response to receiving a confirmation operation by the first user via the confirmation screen.

5. The information processing system according to claim 4, wherein
if an application for displaying the video terminates prior to the confirmation operation by the first user, the one or more processors generate information for displaying in the video any one of the result screen, the change screen and the confirmation screen when the one or more processors subsequently receive another lottery request from the first user terminal or when the one or more processors receive a display request for an item stored in association with the first user.

6. The information processing system according to claim 3, wherein
the one or more processors further change the image of the first item displayed on the result screen to the image of the second item, in response to the image of the second item displayed on the change screen being selected by the first user.

7. The information processing system according to claim 3, wherein
the one or more processors display a predetermined icon attached to the image of the first item.

8. The information processing system according to claim 3, wherein
when there is a plurality of second items with which the first item can be replaced, the one or more processors determine a display order and/or a display format of images of the second items displayed on the change screen, based on user information and/or event information associated with the second items.

9. The information processing system according to claim 8, wherein
the user information associated with the second items is the number of users associated with each of the second items.

10. The information processing system according to claim 8, wherein
the users associated with the second items are users having a predetermined relationship with the first user.

11. The information processing system according to claim 1, wherein
the one or more processors further generate information for displaying the video on a second user terminal of a second user.

12. The information processing system according to claim 11, wherein
the one or more processors further receive, from the second user terminal, a comment about the video and/or a display request for an object.

13. The information processing system according to claim 12, wherein
the one or more processors further receive, from the first user terminal, a switch operation for displaying or not displaying the comment and/or the object in the video during display of the result screen.

14. The information processing system according to claim 13, wherein
the switch operation is an operation that selects a region of the video outside the result screen.

15. The information processing system according to claim 13, wherein
when the comment and/or the object is displayed through the switch operation, the one or more processors change the display format of the comment and/or the object so that the comment and/or the object is displayed without overlapping the result screen displayed in the video.

16. The information processing system according to claim 1, wherein
the one or more processors are further programmed to:
determine whether or not the lottery request is for a specific item group, and
determine whether the first item is replaceable with the second item when the lottery request is for the specific item group.

17. The information processing system according to claim 1, wherein
the second item differs from the first item only in color and/or texture.

18. The information processing system according to claim 1, wherein
the first item is a part that makes up the character object.

19. An information processing method comprising:
generating information for displaying, on at least a first user terminal, a video that displays at least a first character object of a first user in a virtual space;
receiving a lottery request for an item from the first user terminal;
executing a lottery process that determines a first item from among an item group including a plurality of items, in response to receiving the lottery request;
determining whether the first item determined by the lottery process is replaceable with a second item related to the first item; and
generating information for displaying in the video a result screen showing a result of the lottery process, the result screen including an image of the first item determined to be replaceable with the second item.

20. A non-transitory computer-readable medium storing thereon a program causing one or more processors to:
generate information for displaying, on at least a first user terminal, a video that displays at least a first character object of a first user in a virtual space;
receive a lottery request for an item from the first user terminal;
execute a lottery process that determines a first item from among an item group including a plurality of items, in response to receiving the lottery request;
determine whether the first item determined by the lottery process is replaceable with a second item related to the first item; and
generate information for displaying in the video a result screen showing a result of the lottery process, the result screen including an image of the first item determined to be replaceable with the second item.

21. An information processing apparatus comprising:
a processor programmed to:
generate information for displaying, on at least a first user terminal, a video that displays at least a first character object of a first user in a virtual space,
receive a lottery request for an item from the first user terminal,
execute a lottery process that determines a first item from among an item group including a plurality of items, in response to receiving the lottery request,
determine whether the first item determined by the lottery process is replaceable with a second item related to the first item, and
generate information for displaying in the video a result screen showing a result of the lottery process, the result screen including an image of the first item determined to be replaceable with the second item.
